(19) United States
(12) Patent Application Publication
(10) Pub. No.: US 2014/0203907 A1
(43) Pub. Date: Jul. 24, 2014

(54) COMMUNICATION SYSTEM AND COMMUNICATION DEVICE

(71) Applicants: Hirofumi Ohata, Aichi (JP); Yosuke Tomita, Aichi (JP); Daisuke Yoshizawa, Aichi (JP); Takahiro Inaguma, Aichi (JP); Kenichi Kessoku, Aichi (JP); Shuji Yamashita, Aichi (JP)

(72) Inventors: Hirofumi Ohata, Aichi (JP); Yosuke Tomita, Aichi (JP); Daisuke Yoshizawa, Aichi (JP); Takahiro Inaguma, Aichi (JP); Kenichi Kessoku, Aichi (JP); Shuji Yamashita, Aichi (JP)

(73) Assignee: OMRON AUTOMOTIVE ELECTRONICS CO., LTD., Aichi (JP)

(21) Appl. No.: 14/159,902

(22) Filed: Jan. 21, 2014

(30) Foreign Application Priority Data
Jan. 21, 2013 (JP) 2013-008644

(51) Int. Cl. G07C 9/00

(52) U.S. Cl. CPC G07C 9/00007
USPC 340/5.61; 340/5.64

(57) ABSTRACT

A communication system has a first communication device, and a second communication device that conducts wireless communication with the first communication device. The first communication device has a first transmitter that transmits a signal to the second communication device, and a first transmission controller that controls the first transmitter. The second communication device has a first receiver that receives the signal from the first communication device, a measurement part that measures a reception intensity of the signal received by the first receiver, and a determination part that determines whether the signal received by the first receiver is a normal signal. The first transmission controller divides a predetermined portion of a predetermined signal into a plurality of portions when transmitting the predetermined signal.

### BACKGROUND OF THE INVENTION

1. Technical Field

The present invention relates to a communication system and a communication device, particularly to a communication system and a communication device, which makes a relay attack difficult to perform.

2. Related Art

Nowadays, an electronic key system is popular. The electronic key system includes a function (hereinafter referred to as an automatic entry function) in which a door of a vehicle can be locked and unlocked without using a mechanical key or without operating a portable key by conducting wireless communication between an in-vehicle communication device provided in the vehicle and the portable key possessed by a user.

The automatic entry function is roughly divided into the following two kinds of methods. In the first method, the door of the vehicle is automatically locked and unlocked when a user who possesses the portable key performs a predetermined operation (such that the user touches the door or such that the user operates a button provided in the door). For example, when the user performs the predetermined operation to the vehicle, an authentication request signal is transmitted from the in-vehicle communication device to a predetermined area, the portable key that receives the authentication request signal transmits a response signal including the authentication information, and the door is locked or unlocked when the authentication is successfully performed.

In the second method, the door is automatically unlocked when the user who possesses the portable key comes close to the vehicle, and the door is automatically locked when the user moves away from the vehicle. For example, the authentication request signal is periodically transmitted from the in-vehicle communication device to the predetermined area, the portable key that receives the authentication request signal transmits the response signal including the authentication information, the door is locked or unlocked when the authentication is successfully performed, and the door is locked when the response signal cannot be received.

The vehicle including the automatic entry function has a risk of a theft or an intrusion by a technique called a relay attack. As used herein, the relay attack is a technique in which, although the user who possesses the portable key exists outside a communication area of the in-vehicle communication device, a malicious third party enables the communication between the in-vehicle communication device and the portable key to be conducted using a repeater, and perform such a fraud that the door of the vehicle is unlocked.

Conventionally, for the purpose of a countermeasure against the relay attack, Japanese Unexamined Patent Publication No. 2010-185186 proposes that an intensity measuring signal in which an intensity changes in midstream in-vehicle communication device is added to a request signal. Only when a detection value of the change in intensity of the intensity measuring signal is greater than or equal to a predetermined value, the portable key transmits an answer signal to the in-vehicle communication device, whereby the relay attack is difficult to perform.

In a proposal made by Japanese Unexamined Patent Publication No. 2012-52361, the portable key sends back ID with a pattern at a variable signal level similar to a variable signal level portion included in a polling signal from the in-vehicle communication device, and the in-vehicle communication device performs matching of the pattern and ID at the variable signal level. The door of the vehicle is performed when the matching is successfully performed for both the pattern and the ID. Therefore, the relay attack is difficult to perform.

In a proposal made by Japanese Unexamined Patent Publication No. 2011-229061, the in-vehicle communication device transmits two kinds of LF signals having different transmission intensities, the portable key calculates RSSI (Received Signal Strength Indication) of the LF signal, and one of the in-vehicle communication device and the portable key determines the calculated RSSI. A recognition of normal communication is gained when the RSSI values differ from each other, and a recognition of unfair communication is gained when the RSSI values are equal to each other, whereby the relay attack is difficult to perform.

### SUMMARY

One or more embodiments of the present invention makes it difficult to perform a relay attack.

In accordance with one or more embodiments of the present invention, in a communication system in which a first communication device and a second communication device conduct wireless communication with each other, the first communication device includes: a first transmitter that transmits a signal to the second communication device; and a first transmission controller that controls the first transmitter, the second communication device includes: a first receiver that receives the signal from the first communication device; a measurement part that measures a reception intensity of the signal received by the first receiver; and a determination part that determines whether the signal received by the first receiver is a normal signal, the first transmission controller divides a predetermined portion of a predetermined signal into a plurality of portions when transmitting the predetermined signal, and adjusts a transmission intensity of each divided portion such that a change in transmission intensity has a predetermined pattern in the whole predetermined portion of the predetermined signal, the measurement part measures the reception intensity of the predetermined portion of the predetermined signal, and the determination part determines whether the predetermined signal is the normal signal based on whether the change in reception intensity of the predetermined portion of the predetermined signal is matched with the predetermined pattern.

In one or more embodiments of the present invention, the predetermined portion of the predetermined signal is divided into the plurality of portions when the predetermined signal is transmitted, the transmission intensity of each divided portion is adjusted, the change in transmission intensity changes so as to have the predetermined pattern in the whole predetermined portion of the predetermined signal, the reception intensity of the predetermined portion of the predetermined signal is measured, and whether the predetermined signal is the normal signal is determined based on whether the change in reception intensity of the predetermined portion of the predetermined signal is matched with the predetermined pattern.

Accordingly, the relay attack may be difficult to perform.

For example, one of the first communication device and the second communication device is constructed by a vehicle key fob, and the other is constructed by an in-vehicle communication device. For example, the first transmitter is constructed by various transmitting circuits or a dedicated IC. For example, the first transmission controller and the determination part are constructed by a microcomputer including a processor such as a CPU (Central Processing Unit), or an ECU (Electronic Control Unit). For example, the first receiver is constructed by various receiving circuits or a dedicated IC. For example, the measurement part is constructed by an RSSI measurement circuit or a microcomputer including a processor such as a CPU.

In a communication system according to one or more embodiments of the present invention, the first communication device may further includes: a second receiver that receives a signal from the second communication device; the second communication device may further include: second transmitter that transmits the signal to the first communication device; and a second transmission controller that controls the second transmitter, the second transmission controller may perform control so as to transmit a signal making notification that the reception intensity is saturated, when the reception intensity of the predetermined portion of the predetermined signal is saturated, and the first transmission controller may perform control such that retransmission is performed while the transmission intensity of at least the predetermined portion is lowered, when the notification that the reception intensity is saturated is made.

Accordingly, a determination whether the predetermined signal is the normal signal is prevented from being mistakenly made due to saturation of the reception intensity.

For example, the second receiver is constructed by various receiving circuits or a dedicated IC. For example, the second transmitter is constructed by various transmitting circuits or a dedicated IC. For example, the second transmission controller is constructed by a microcomputer including a processor such as a CPU, or an ECU.

In a communication system according to one or more embodiments of the present invention, the first transmission controller may perform control such that notification of information on the predetermined pattern is made while the information on the predetermined pattern is included in the predetermined signal content, and the determination part may determine whether the predetermined signal is the normal signal based on the notified predetermined pattern.

Therefore, the relay attack may be difficult to perform.

In accordance with one or more embodiments of the present invention, a communication device that conducts wireless communication with another communication device, the communication device includes: a transmitter that transmits a signal to the other communication device; and a transmission controller that controls the transmitter. In the communication device, the transmission controller divides a predetermined portion of a predetermined signal into a plurality of portions when transmitting the predetermined signal, and adjusts a transmission intensity of each divided portion such that a change in transmission intensity has a predetermined pattern in the whole predetermined portion of the predetermined signal.

In one or more embodiments of the present invention, the predetermined portion of the predetermined signal is divided into the plurality of portions when the predetermined signal is transmitted, the transmission intensity of each divided portion is adjusted, and the change in transmission intensity changes so as to have the predetermined pattern in the whole predetermined portion of the predetermined signal.

Accordingly, the relay attack may be difficult to perform.

For example, the transmitter is constructed by various transmitting circuits or a dedicated IC. For example, the transmission controller is constructed by a microcomputer including a processor such as a CPU, or an ECU.

In accordance with one or more embodiments of the present invention, a communication device that conducts wireless communication with another communication device, the communication device includes: a receiver that receives a signal from the other communication device; a measurement part that measures a reception intensity of the signal received by the receiver; and a determination part that determines whether the signal received by the first receiver is a normal signal. In the communication device, the measurement part measures the reception intensity of a predetermined portion of a predetermined signal transmitted from the other communication device, and the determination part determines whether the predetermined signal is the normal signal based on whether the change in reception intensity of the predetermined portion of the predetermined signal is matched with a predetermined pattern.

In one or more embodiments of the present invention, the reception intensity of a predetermined portion of a predetermined signal transmitted from the other communication device is measured, and whether the predetermined signal is the normal signal is determined based on whether the change in reception intensity of the predetermined portion of the predetermined signal is matched with a predetermined pattern.

Accordingly, the relay attack may be difficult to perform.

For example, the receiver is constructed by various receiving circuits or a dedicated IC. For example, the measurement part is constructed by an RSSI measurement circuit or a microcomputer including a processor such as a CPU. For example, the determination part is constructed by a microcomputer including a processor such as a CPU, or an ECU.

In accordance with one or more embodiments of the present invention, in a communication system in which a first communication device and a second communication device conduct wireless communication with each other, the first communication device includes: a first transmitter that transmits a signal to the second communication device; and a first transmission controller that controls the first transmitter, the second communication device includes: a first receiver that receives the signal from the first communication device; a measurement part that measures a reception intensity of the signal received by the first receiver; and a determination part that determines whether the signal received by the first receiver is a normal signal, the first transmission controller performs control such that a predetermined signal is repeatedly transmitted predetermined times and such that a change in transmission intensity between the predetermined signals is changed according to a predetermined pattern, the measurement part measures the reception intensities of the predetermined signals that are repeatedly transmitted the predetermined times, and the determination part determines whether the predetermined signal is the normal signal based on whether the change in reception intensity between the predetermined signals is matched with the predetermined pattern.

In one or more embodiments of the present invention, the predetermined signal is repeatedly transmitted predetermined times, the change in transmission intensity between the predetermined signals is changed according to the predetermined pattern, the reception intensities of the predetermined signals that are repeatedly transmitted the predetermined times are measured, and whether the predetermined signal is the normal signal is determined based on whether the change in reception intensity between the predetermined signals is matched with the predetermined pattern.

Accordingly, the relay attack may be difficult to perform.

For example, one of the first communication device and the second communication device is constructed by a vehicle key fob, and the other is constructed by an in-vehicle communication device. For example, the first transmitter is constructed by various transmitting circuits or a dedicated IC. For example, the first transmission controller and the determination part are constructed by a microcomputer including a processor such as a CPU, or an ECU. For example, the first receiver is constructed by various receiving circuits or a dedicated IC. For example, the measurement part is constructed by an RSSI measurement circuit or a microcomputer including a processor such as a CPU.

In a communication system according to one or more embodiments of the present invention, the first communication device further includes: a second receiver that receives a signal from the second communication device, the second communication device further includes: a second transmitter that transmits the signal to the first communication device; and a second transmission controller that controls the second transmitter, the second transmission controller performs control so as to transmit a signal making notification that the reception intensity is saturated, when the reception intensity of the predetermined signal is saturated, and the first transmission controller performs control such that the predetermined signal is repeatedly retransmitted predetermined times while the transmission intensity is lowered, when the notification that the reception intensity is saturated is made.

Accordingly, the determination whether the predetermined signal is the normal signal is prevented from being mistakenly made due to the saturation of the reception intensity.

For example, the second receiver is constructed by various receiving circuits or a dedicated IC. For example, the second transmitter is constructed by various transmitting circuits or a dedicated IC. For example, the second transmission controller is constructed by a microcomputer including a processor such as a CPU, or an ECU.

In a communication system according to one or more embodiments of the present invention, the first transmission controller may perform control such that notification of information on the predetermined pattern is made while the information on the predetermined pattern is included in one or all of the predetermined signals transmitted a plurality of times, and the determination part may determine whether the predetermined signal is the normal signal based on the notified predetermined pattern.

Therefore, the relay attack may be difficult to perform.

In accordance with one or more embodiments of the present invention, a communication device that conducts wireless communication with another communication device, the communication device includes: a transmitter that transmits a signal to the other communication device; and a transmission controller that controls the transmitter. In the communication device, the transmission controller performs control such that a predetermined signal is repeatedly transmitted predetermined times and such that a change in transmission intensity between the predetermined signals is changed according to a predetermined pattern.

In one or more embodiments of the present invention, the predetermined signal is repeatedly transmitted predetermined times, and the change in transmission intensity between the predetermined signals is changed according to a predetermined pattern.

Accordingly, the relay attack may be difficult to perform.

For example, the transmitter is constructed by various transmitting circuits or a dedicated IC. For example, the transmission controller is constructed by a microcomputer including a processor such as a CPU, or an ECU.

In accordance with one or more embodiments of the present invention, a communication device that conducts wireless communication with another communication device, the communication device includes: a receiver that receives a signal from the communication device; a measurement part that measures a reception intensity of the signal received by the receiver; and a determination part that determines whether the signal received by the first receiver is a normal signal. In the communication device, the measurement part measures the reception intensities of the predetermined signals that are repeatedly transmitted the predetermined times from the communication device, and the determination part determines whether the predetermined signal is the normal signal based on whether the change in reception intensity between the predetermined signals is matched with a predetermined pattern.

In one or more embodiments of the present invention, the reception intensities of the predetermined signals that are repeatedly transmitted the predetermined times from the other communication device are measured, and whether the predetermined signal is the normal signal is determined based on whether the change in reception intensity between the predetermined signals is matched with the predetermined pattern.

Accordingly, the relay attack may be difficult to perform.

For example, the receiver is constructed by various receiving circuits or a dedicated IC. For example, the measurement part is constructed by an RSSI measurement circuit or a microcomputer including a processor such as a CPU. For example, the determination part is constructed by a microcomputer including a processor such as a CPU, or an ECU.

In accordance with one or more embodiments of the present invention, in a communication system in which a first communication device and a second communication device conduct wireless communication with each other, the first communication device includes: a first transmitter that transmits a signal to the second communication device; a first transmission controller that controls the first transmitter; a first receiver that receives a signal from the second communication device; and a determination part that determines whether the signal received by the second communication device is a normal signal, the second communication device includes: a second receiver that receives the signal from the first communication device; a measurement part that measures a reception intensity of the signal received by the second receiver; a second transmitter that transmits the signal to the first communication device; and a second transmission controller that controls the second transmitter, the first transmission controller divides a predetermined portion of a predetermined first signal into a plurality of portions when transmitting the first signal, and adjusts a transmission intensity of each divided portion such that a change in transmission intensity has a predetermined pattern in the whole predetermined portion of the first signal, the measurement part measures the reception intensity of the predetermined portion of the first signal, the second transmission controller performs control so as to transmit a second signal including a measurement result of the reception intensity of the predetermined portion of the first signal in response to the first signal, and the determination part determines whether the first signal received by the second communication device is the normal signal based on whether the change in reception intensity of the predetermined portion of the first signal in the second communication device is matched with the predetermined pattern.

In one or more embodiments of the present invention, the predetermined portion of the predetermined first signal is divided into the plurality of portions when the predetermined first signal is transmitted, the transmission intensity of each divided portion is adjusted, the change in transmission intensity changes so as to have the predetermined pattern in the whole predetermined portion of the first signal, the reception intensity of the predetermined portion of the first signal is measured, the second signal including the measurement result of the reception intensity of the predetermined portion of the first signal is transmitted in response to the first signal, and whether the first signal received by the second communication device is the normal signal is determined based on whether the change in reception intensity of the predetermined portion of the first signal in the second communication device is matched with the predetermined pattern.

Accordingly, the relay attack may be difficult to perform.

For example, the first communication device is constructed by an in-vehicle communication device. For example, the second communication device is constructed by a vehicle key fob. For example, the first transmitter and the second transmitter are constructed by various transmitting circuits or a dedicated IC. For example, the first transmission controller, the second transmission controller, and the determination part are constructed by a microcomputer including a processor such as a CPU, or an ECU. For example, the first receiver and the second receiver are constructed by various receiving circuits or a dedicated IC. For example, the measurement part is constructed by an RSSI measurement circuit or a microcomputer including a processor such as a CPU.

In a communication system according to one or more embodiments of the present invention, the first transmission controller may perform control such that retransmission is performed while the transmission intensity of at least the predetermined portion is lowered, when the reception intensity of the predetermined portion of the first signal is saturated in the second communication device.

Accordingly, the determination whether the first signal is the normal signal is prevented from being mistakenly made due to the saturation of the reception intensity.

In accordance with one or more embodiments of the present invention, a communication device that conducts wireless communication with another communication device, the communication device includes: a transmitter that transmits a signal to the communication device; a transmission controller that controls the transmitter; a receiver that receives a signal from the other communication device; and a determination part that determines whether the signal received by the other communication device is a normal signal. In the communication device, the transmission controller divides a predetermined portion of a predetermined first signal into a plurality of portions when transmitting the first signal, and adjusts a transmission intensity of each divided portion such that a change in transmission intensity has a predetermined pattern in the whole predetermined portion of the first signal, and the determination part determines whether the first signal received by the second communication device is the normal signal by determining whether the change in reception intensity of the predetermined portion of the first signal in the second communication device is matched with the predetermined pattern based on a measurement result of the reception intensity of the predetermined portion of the first signal, the measurement result of the reception intensity of the predetermined portion of the first signal being included in a second signal transmitted from the other communication device in response to the first signal.

In one or more embodiments of the present invention, the predetermined portion of the predetermined first signal is divided into the plurality of portions when the first signal is transmitted, the transmission intensity of each divided portion is adjusted, the change in transmission intensity changes so as to have the predetermined pattern in the whole predetermined portion of the first signal, and whether the first signal received by the second communication device is the normal signal is determined by determining whether the change in reception intensity of the predetermined portion of the first signal in the second communication device is matched with the predetermined pattern based on the measurement result of the reception intensity of the predetermined portion of the first signal, the measurement result of the reception intensity of the predetermined portion of the first signal being included in the second signal transmitted from the other communication device in response to the first signal.

Accordingly, the relay attack may be difficult to perform.

For example, the transmitter is constructed by various transmitting circuits or a dedicated IC. For example, the transmission controller and the determination part are constructed by a microcomputer including a processor such as a CPU, or an ECU. For example, the receiver is constructed by various receiving circuits or a dedicated IC.

In accordance with one or more embodiments of the present invention, a communication device that conducts wireless communication with another communication device, the communication device includes: a receiver that receives a signal from the other communication device; a measurement part that measures a reception intensity of the signal received by the receiver; a transmitter that transmits a signal to the other communication device; and a transmission controller that controls the transmitter. In the communication device, the measurement part measures the reception intensity of a predetermined portion of a predetermined first signal transmitted from the other communication device, and the transmission controller performs control so as to transmit a second signal including a measurement result of the reception intensity of the predetermined portion of the first signal in response to the first signal.

In one or more embodiments of the present invention, the reception intensity of the predetermined portion of the predetermined first signal transmitted from the other communication device is measured, and the second signal including the measurement result of the reception intensity of the predetermined portion of the first signal is transmitted in response to the first signal.

Accordingly, the relay attack may be difficult to perform.

For example, the receiver is constructed by various receiving circuits or a dedicated IC. For example, the measurement part is constructed by an RSSI measurement circuit or a microcomputer including a processor such as a CPU. For example, the transmitter is constructed by various transmitting circuits or a dedicated IC. For example, the transmission controller is constructed by a microcomputer including a processor such as a CPU, or an ECU.

In accordance with one or more embodiments of the present invention, in a communication system in which a first communication device and a second communication device conduct wireless communication with each other, the first communication device includes: a first transmitter that transmits a signal to the second communication device; a first transmission controller that controls the first transmitter; a first receiver that receives a signal from the second communication device; and a determination part that determines whether the signal received by the second communication device is a normal signal, the second communication device includes: a second receiver that receives the signal from the first communication device; a measurement part that measures a reception intensity of the signal received by the second receiver; a second transmitter that transmits the signal to the first communication device; and a second transmission controller that controls the second transmitter, the first transmission controller performs control such that a predetermined first signal is repeatedly transmitted predetermined times and such that a change in transmission intensity between the first signals is changed according to a predetermined pattern, the measurement part measures the reception intensities of the first signals that are repeatedly transmitted the predetermined times, the second transmission controller performs control so as to transmit a second signal including a measurement result of the reception intensity of the first signal in response to the first signal, and the determination part determines whether the first signal received by the second communication device is the normal signal based on whether the change in reception intensity between the first signals in the second communication device is matched with the predetermined pattern.

In one or more embodiments of the present invention, the predetermined first signal is repeatedly transmitted predetermined times, the change in transmission intensity between the first signals is changed according to the predetermined pattern, the reception intensities of the first signals that are repeatedly transmitted the predetermined times are measured, the second signal including a measurement result of the reception intensity of the first signal is transmitted in response to the first signal, and whether the first signal received by the second communication device is the normal signal is determined based on whether the change in reception intensity between the first signals in the second communication device is matched with the predetermined pattern.

Accordingly, the relay attack may be difficult to perform.

For example, the first communication device is constructed by an in-vehicle communication device. For example, the second communication device is constructed by a vehicle key fob. For example, the first transmitter and the second transmitter are constructed by various transmitting circuits or a dedicated IC. For example, the first transmission controller, the second transmission controller, and the determination part are constructed by a microcomputer including a processor such as a CPU, or an ECU. For example, the first receiver and the second receiver are constructed by various receiving circuits or a dedicated IC. For example, the measurement part is constructed by an RSSI measurement circuit or a microcomputer including a processor such as a CPU.

In a communication system according to one or more embodiments of the present invention, the first transmission controller may perform control such that the first signal is retransmitted predetermined times while the transmission intensity is lowered, when the reception intensity of the first signal is saturated in the second communication device.

Accordingly, the determination whether the first signal is the normal signal is prevented from being mistakenly made due to the saturation of the reception intensity.

In accordance with one or more embodiments of the present invention, a communication device that conducts wireless communication with another communication device, the communication device includes: a transmitter that transmits a signal to the other communication device; a transmission controller that controls the transmitter; a receiver that receives a signal from the other communication device; and a determination part that determines whether the signal received by the other communication device is a normal signal. In the communication device, the transmission controller performs control such that a predetermined first signal is repeatedly transmitted predetermined times and such that a change in transmission intensity between the first signals is changed according to a predetermined pattern, the measurement part measures the reception intensities of the first signals that are repeatedly transmitted the predetermined times, and the determination part determines whether the first signal received by the second communication device is the normal signal by determining whether the change in reception intensity between the first signals in the second communication device is matched with the predetermined pattern based on a measurement result of the reception intensity of the first signal, the measurement result of the reception intensity of the first signal being included in a second signal transmitted from the other communication device in response to the first signal.

In one or more embodiments of the present invention, the predetermined first signal is repeatedly transmitted predetermined times, the change in transmission intensity between the first signals is changed according to the predetermined pattern, the reception intensities of the first signals that are repeatedly transmitted the predetermined times are measured, and whether the first signal received by the second communication device is the normal signal is determined by determining whether the change in reception intensity between the first signals in the second communication device is matched with the predetermined pattern based on the measurement result of the reception intensity of the first signal, the measurement result of the reception intensity of the first signal being included in the second signal transmitted from the other communication device in response to the first signal.

Accordingly, the relay attack may be difficult to perform.

For example, the transmitter is constructed by various transmitting circuits or a dedicated IC. For example, the transmission controller and the determination part are constructed by a microcomputer including a processor such as a CPU, or an ECU. For example, the receiver is constructed by various receiving circuits or a dedicated IC.

In accordance with one or more embodiments of the present invention, a communication device that conducts wireless communication with another communication device, the communication device includes: a receiver that receives a signal from the other communication device; a measurement part that measures a reception intensity of the signal received by the receiver; a transmitter that transmits a signal to the other communication device; and a transmission controller that controls the transmitter. In the communication device, the measurement part measures the reception intensities of predetermined first signals that are repeatedly transmitted the predetermined times from the other communication device, and the transmission controller performs control so as to transmit a second signal including a measurement result of the reception intensity of the first signal in response to the first signal.

In one or more embodiments of the present invention, the reception intensities of predetermined first signals that are repeatedly transmitted the predetermined times from the other communication device are measured, and the second signal including the measurement result of the reception intensity of the first signal is transmitted in response to the first signal.

Accordingly, the relay attack may be difficult to perform.

For example, the receiver is constructed by various receiving circuits or a dedicated IC. For example, the measurement part is constructed by an RSSI measurement circuit or a microcomputer including a processor such as a CPU. For example, the transmitter is constructed by various transmitting circuits or a dedicated IC. For example, the transmission controller is constructed by a microcomputer including a processor such as a CPU, or an ECU.

According to one or more embodiments of the present invention, the relay attack may be difficult to perform.

### BRIEF DESCRIPTION OF THE DRAWINGS

FIG. 1 is a block diagram illustrating a communication system according to one or more embodiments of the present invention;

FIG. 2 is a chart illustrating a first embodiment of authentication request signal transmitting processing performed by an in-vehicle communication device;

FIG. 3 is a diagram illustrating a configuration example of an authentication request signal;

FIG. 4 is a diagram illustrating a first example of a transmission intensity pattern;

FIG. 5 is a diagram illustrating a second example of the transmission intensity pattern;

FIG. 6 is a diagram illustrating a third example of the transmission intensity pattern;

FIG. 7 is a flowchart illustrating a first embodiment of authentication request signal receiving processing performed by a portable key;

FIG. 8 is a flowchart illustrating a second embodiment of the authentication request signal receiving processing performed by the portable key;

FIG. 9 is a chart illustrating a second embodiment of the authentication request signal transmitting processing performed by the in-vehicle communication device;

FIG. 10 is a diagram illustrating a transmission pattern example of the authentication request signal;

FIG. 11 is a flowchart illustrating a third embodiment of the authentication request signal receiving processing performed by the portable key;

FIG. 12 is a flowchart illustrating a fourth embodiment of the authentication request signal receiving processing performed by the portable key;

FIG. 13 is a flowchart illustrating a first embodiment of response signal transmitting processing performed by the portable key;

FIG. 14 is a diagram illustrating a configuration example of a response signal;

FIG. 15 is a flowchart illustrating a first embodiment of the response signal receiving processing performed by the in-vehicle communication device;

FIG. 16 is a flowchart illustrating a second embodiment of the response signal receiving processing performed by the in-vehicle communication device;

FIG. 17 is a flowchart illustrating a second embodiment of the response signal transmitting processing performed by the portable key;

FIG. 18 is a diagram illustrating a transmission pattern example of the response signal;

FIG. 19 is a flowchart illustrating a third embodiment of the response signal receiving processing performed by the in-vehicle communication device;

FIG. 20 is a flowchart illustrating a fourth embodiment of the response signal receiving processing performed by the in-vehicle communication device;

FIG. 21 is a flowchart illustrating a first embodiment of processing performed by the in-vehicle communication device when the in-vehicle communication device determines a reception intensity of the portable key;

FIG. 22 is a flowchart illustrating a first embodiment of processing performed by the portable key when the in-vehicle communication device determines the reception intensity of the portable key;

FIG. 23 is a flowchart illustrating a second embodiment of the processing performed by the in-vehicle communication device when the in-vehicle communication device determines the reception intensity of the portable key; and

FIG. 24 is a flowchart illustrating a second embodiment of the processing performed by the portable key when the in-vehicle communication device determines the reception intensity of the portable key.

### DETAILED DESCRIPTION

Hereinafter, embodiments of the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

[Configuration Example of Communication System 101]

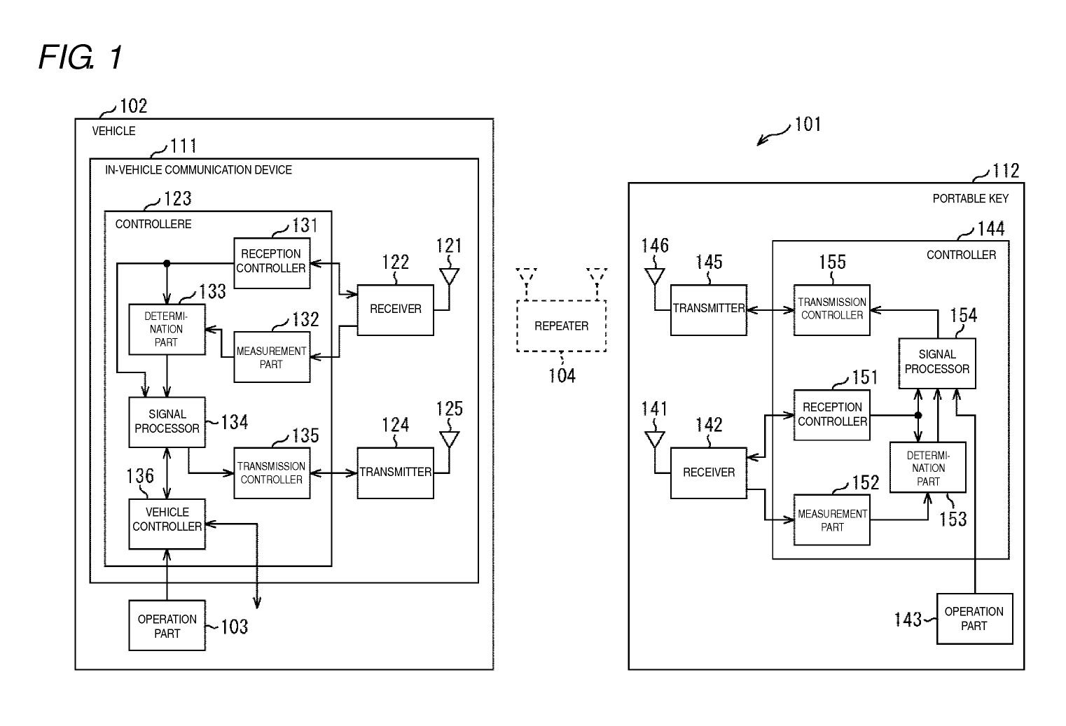

FIG. 1 is a block diagram illustrating a communication system 101 according to one or more embodiments of the present invention. The communication system 101 is used to implement a predetermined function of a vehicle 102. As used herein, for example, the predetermined function means a function of locking and unlocking a door of the vehicle 102 (automatic entry function) without using a mechanical key or operating a portable key 112, a function of starting up a driving machine such as an engine and a motor only by operating a button of the vehicle 102 (hereinafter referred to as a push start function) or a function of lighting a welcome lamp (hereinafter referred to as a welcome lamp lighting function). The welcome lamp is provided in a car or near a door mirror in order to check a situation of the vehicle 102 or a surrounding area in the dark.

As described later, in the communication system 101, a countermeasure is taken to prevent a relay attack in which a repeater 104 is used.

The communication system 101 includes an in-vehicle communication device 111 provided in the vehicle 102 and the portable key 112 possessed by a user. The in-vehicle communication device 111 and the portable key 112 conduct bidirectional wireless communication with each other.

The in-vehicle communication device 111 includes an antenna 121, a receiver 122, a controller 123, a transmitter 124, and an antenna 125.

For example, the receiver 122 is constructed by various receiving circuits or a dedicated IC. Under control of a reception controller 131 of the controller 123, the receiver 122 receives a UHF-band signal (hereinafter referred to as an RF signal) from the portable key 112 through the antenna 121, and demodulates the received RF signal. The receiver 122 supplies the baseband signal obtained by demodulating the RF signal to the reception controller 131. The receiver 122 supplies the pre-demodulation RF signal to the measurement part 132.

For example, the controller 123 is constructed by a microcomputer including a processor such as a CPU (Central Processing Unit) or an ECU (Electronic Control Unit). The controller 123 includes a reception controller 131, a measurement part 132, a determination part 133, a signal processor 134, a transmission controller 135, and a vehicle controller 136.

The reception controller 131 controls the receiver 122. The reception controller 131 supplies to the determination part 133 and the signal processor 134 the baseband signal supplied from the receiver 122.

The measurement part 132 measures an intensity of the RF signal received from the portable key 112, and notifies the determination part 133 of a measurement result.

Based on the measurement result of the reception intensity of the RF signal and a content of the RF signal, the determination part 133 determines whether the received RF signal is a normal signal, and notifies the signal processor 134 of a determination result. Additionally, as described later, the determination part 133 can determine whether the LF signal received from the in-vehicle communication device 111 by the portable key 112 is the normal signal.

The signal processor 134 performs various pieces of signal processing (for example, a signal analysis and processing based on an analysis result) to the baseband signal supplied from the reception controller 131. The signal processor 134 switches between performance and non-performance of the signal processing and between contents of the signal processing based on a determination result of the determination part 133. As needed basis, the signal processor 134 notifies the transmission controller 135 and the vehicle controller 136 of a result of the signal processing. Based on the result of the signal processing or a command issued from the vehicle controller 136, the signal processor 134 generates the signal (baseband signal) to be transmitted to the portable key 112, and supplies the generated signal to the transmission controller 135.

The transmission controller 135 supplies to the transmitter 124 the baseband signal supplied from the signal processor 134. The transmission controller 135 controls the transmitter 124.

The vehicle controller 136 conducts communication with another device (for example, an ECU) provided in the vehicle 102 in order to transmit and receive various pieces of information and to issue and receive the command. The vehicle controller 136 receives the command from an operation part 103 provided in the vehicle 102.

For example, the operation part 103 includes a button, which is provided near the door of the vehicle 102 to perform the automatic entry function, and a button that is provided in the vehicle 102 to perform the push start function.

For example, the transmitter 124 is constructed by various transmitting circuits or a dedicated IC. Under the control of the transmission controller 135, the transmitter 124 modulates the baseband signal supplied from the transmission controller 135 using an LF-band carrier wave. Under the control of the transmission controller 135, the transmitter 124 transmits the modulated signal (hereinafter referred to as an LF signal) to the portable key 112 through the antenna 125.

For example, an ASK (Amplitude Shift Keying) modulation method, an FSK (Frequency Shift Keying) modulation method, and a PSK (Phase Shift Keying) modulation method can be adopted as the modulation method of the transmitter 124. The case that the ASK modulation method is adopted as the modulation method of the transmitter 124 will be described below.

For example, the portable key 112 is constructed by a key fob possessed by a user who uses the vehicle 102. The portable key 112 includes an antenna 141, a receiver 142, an operation part 143, a controller 144, a transmitter 145, and an antenna 146.

For example, receiver 142 is constructed by various receiving circuits or a dedicated IC. Under the control of a reception controller 151 of the controller 144, the receiver 142 receives the LF signal from the in-vehicle communication device 111 through the antenna 141, and demodulates the received LF signal. The receiver 122 supplies the baseband signal obtained by the demodulation of the LF signal to the reception controller 151. The receiver 142 supplies the pre-demodulation LF signal to the measurement part 152.

For example, the operation part 143 is constructed by a button or a switch, and operated when a predetermined operation of the vehicle 102 is performed. The operation part 143 supplies the signal indicating an operation content to the signal processor 154 of the controller 144.

For example, the controller 144 is constructed by the microcomputer including the processor such as the CPU. The controller 144 includes a reception controller 151, a measurement part 152, a determination part 153, a signal processor 154, and a transmission controller 155.

The reception controller 151 controls the receiver 142. The reception controller 151 supplies to the determination part 153 and the signal processor 154 the baseband signal supplied from the receiver 142.

The measurement part 152 measures the intensity of the LF signal received from the in-vehicle communication device 111, and notifies the determination part 153 of the measurement result.

Based on the measurement result of the reception intensity of the LF signal and the content of the LF signal, the determination part 153 determines whether the received LF signal is the normal signal, and notifies the signal processor 154 of the determination result.

The signal processor 154 performs various pieces of signal processing (for example, the signal analysis and the processing based on the analysis result) to the baseband signal supplied from the reception controller 151. The signal processor 154 switches between the performance and non-performance of the signal processing and between the contents of the signal processing based on the determination result of the determination part 153. Based on the result of the signal processing or an operation signal from the operation part 143, the signal processor 154 generates the signal (baseband signal) to be transmitted to the in-vehicle communication device 111, and supplies the generated signal to the transmission controller 155.

The transmission controller 155 supplies to the transmitter 145 the baseband signal supplied from the signal processor 154. The transmission controller 155 controls the transmitter 145.

For example, the transmitter 145 is constructed by various transmitting circuits or a dedicated IC. Under the control of the transmission controller 155, the transmitter 145 modulates the baseband signal supplied from the transmission controller 155 using an UHF-band carrier wave. Under the control of the transmission controller 155, the transmitter 145 transmits the modulated signal (hereinafter referred to as an RF signal) to the in-vehicle communication device 111 through the antenna 146.

For example, an ASK modulation method, a FSK modulation method, and a PSK modulation method can be adopted as the modulation method of the transmitter 145. The case that the FSK modulation method is adopted as the modulation method of the transmitter 145 will be described below.

[Processing of Communication System 101]

Processing of the communication system 101 will be described below. Specifically, in the processing of the communication system 101, the in-vehicle communication device 111 transmits the authentication request signal, the portable key 112 that receives the authentication request signal transmits the response signal, and the in-vehicle communication device 111 that receives the response signal performs the pieces of processing such as the automatic entry function, the push start function, and the welcome lamp lighting function.

[Authentication Request Signal Transmitting and Receiving Processing]

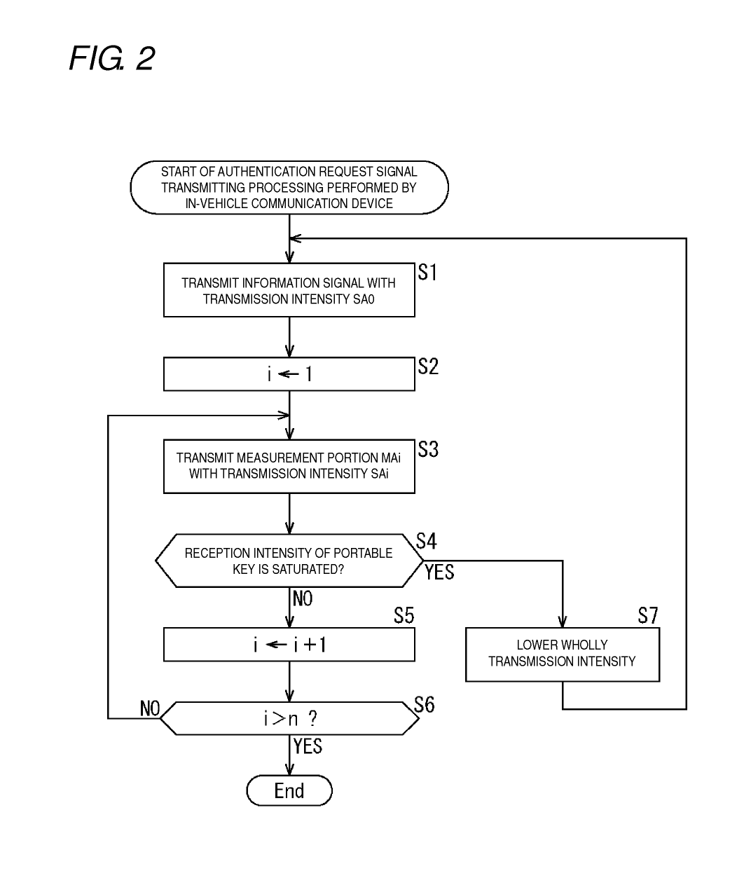

The pieces of processing until the portable key 112 receives the authentication request signal since the in-vehicle communication device 111 transmits the authentication request signal will be described with reference to FIGS. 2 to 12.

(First Embodiment of Authentication Request Signal Transmitting Processing Performed by in-Vehicle Communication Device 111)

A first embodiment of the authentication request signal transmitting processing performed by the in-vehicle communication device 111 will be described with reference to a flowchart in FIG. 2.

For example, the processing of the communication system 101 is performed when a predetermined operation (for example, the user operates the button provided in the door of the vehicle 102) is performed to the operation part 103 of the vehicle 102, or the processing is periodically performed.

In Step S1, the in-vehicle communication device 111 transmits an information signal of the authentication request signal with a transmission intensity SA0.

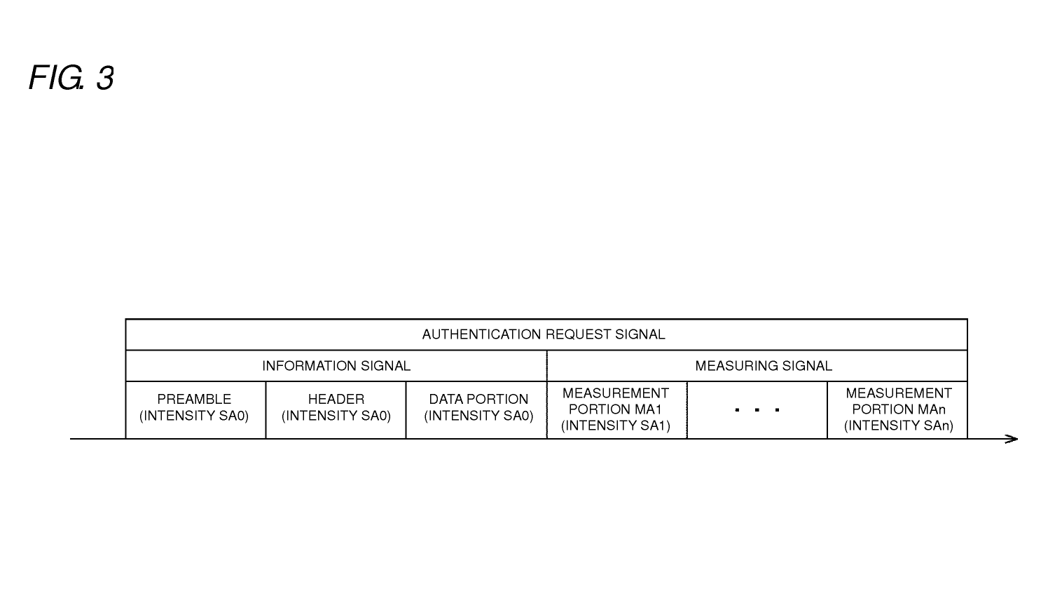

A configuration example of the authentication request signal will be described with reference to FIG. 3.

The authentication request signal is roughly divided into two blocks, namely, an information signal including information necessary for the actual processing and a measuring signal used to measure the reception intensity in the portable key 112. The information signal is divided into three blocks of a preamble, a header, and a data portion.

For example, the preamble is the block that includes a synchronous code having a predetermined value in order to synchronize the in-vehicle communication device 111 and the portable key 112 with each other.

The header is the block that includes data of the signal, such as the kind and the length, which is related to the authentication request signal.

The data portion is the block that includes data necessary for the processing of the portable key 112. For example, the data portion includes authentication information, such as ID, which identifies the in-vehicle communication device 111.

For example, the measuring signal is a CW (Continuous Wave) signal, and is divided into n blocks of measurement portions MA1 to MAn. Desirably a value of n is set to 3 or a greater value.

As described later, the information signal (the preamble, the header, and the data portion) is transmitted with the transmission intensity SA0. The measurement portions MA1 to MAn are transmitted with transmission intensities SA1 to SAn, respectively. That is, in the measuring signal, the transmission intensity changes in units of measurement portions.

The transmission intensity SA0 is set to a standard transmission intensity of the authentication request signal. The transmission intensities SA1 to SAn are not necessarily set to values different from each other, but the plurality of transmission intensities may be set to the identical value. However, the transmission intensities of the measurement portions adjacent to each other are set to different values.

The signal processor 134 generates the authentication request signal, and supplies the authentication request signal to the transmitter 124 through the transmission controller 135. Under the control of the transmission controller 135, the transmitter 124 ASK-modulates the information signal of the authentication request signal, and transmits the modulated information signal through the antenna 125 with the transmission intensity SA0.

In Step S2, the transmission controller 135 sets a variable i to a value of 1.

In Step S3, under the control of the transmission controller 135, the transmitter 124 transmits the measurement portion MAi of the measuring signal of the authentication request signal through the antenna 125 with the transmission intensity SAi.

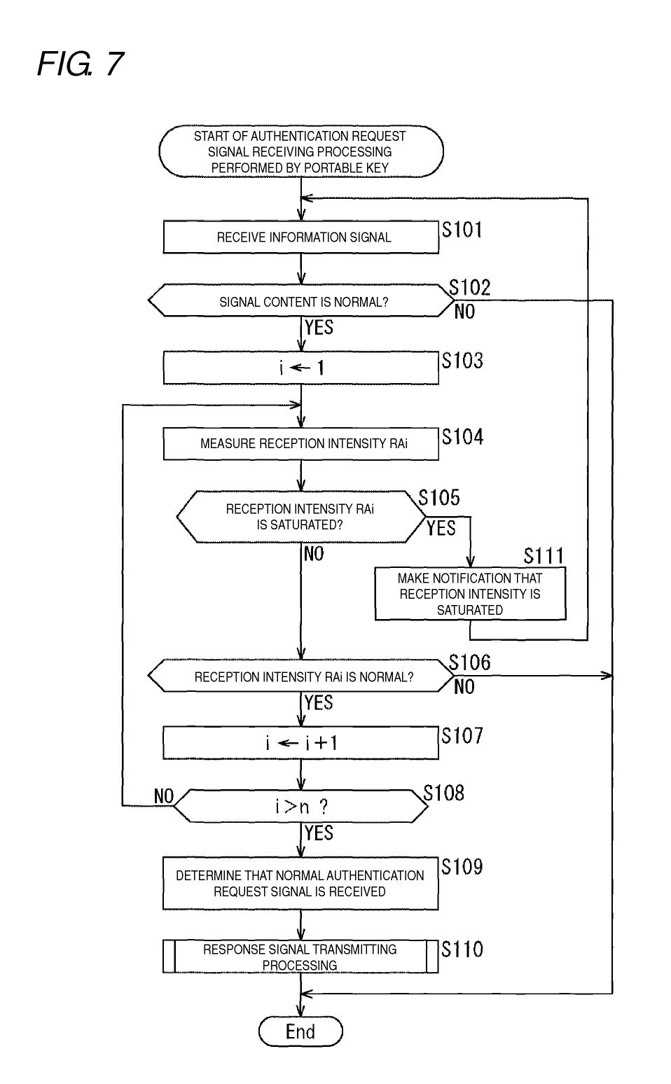

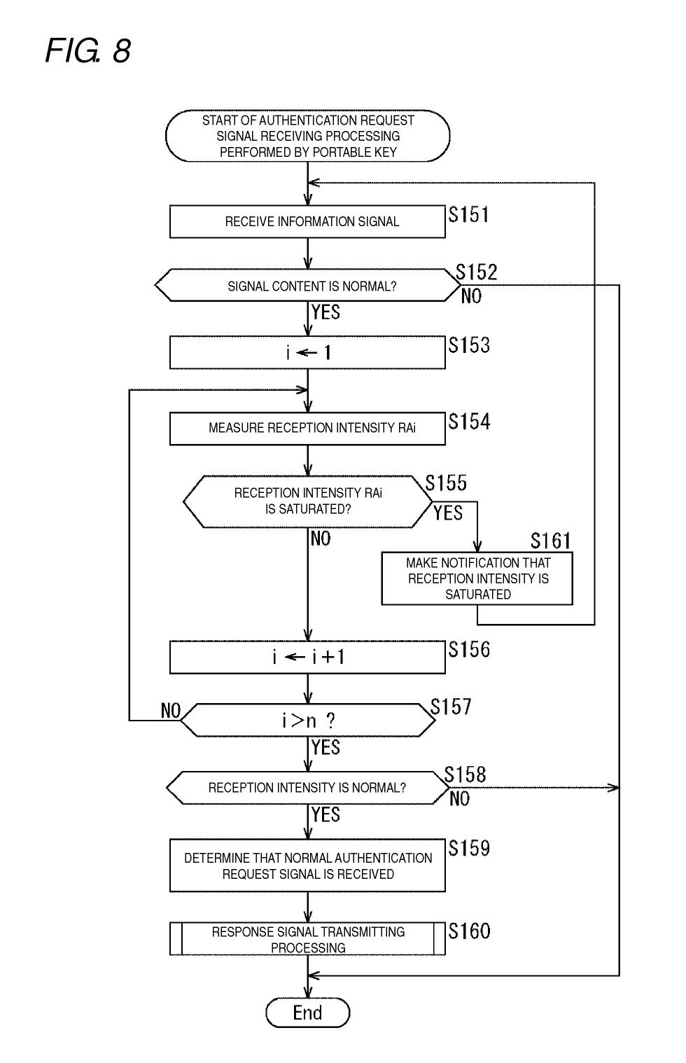

In Step S4, the transmission controller 135 determines whether the reception intensity of the portable key 112 is saturated. Specifically, when the reception intensity of the authentication request signal transmitted from the in-vehicle communication device 111 is saturated, the portable key 112 transmits a reception intensity saturation notification signal in order to make notification that the reception intensity is saturated in Step S111 of FIG. 7 or Step S161 of FIG. 8. When receiving the reception intensity saturation notification signal transmitted from the portable key 112 through the antenna 121, the receiver 122 supplies the reception intensity saturation notification signal to the signal processor 134 through the reception controller 131. The signal processor 134 notifies the transmission controller 135 that the reception intensity saturation notification signal is received.

Unless the transmission controller 135 receives the notification that the reception intensity saturation notification signal is received from the signal processor 134, the transmission controller 135 determines that the reception intensity of the portable key 112 is not saturated, and the flow goes to the processing in Step S5.

In Step S5, the transmission controller 135 increments the value of the variable i by 1.

In Step S6, the transmission controller 135 determines whether the variable is greater than a constant n. When the variable i is determined to be less than or equal to the constant n, the flow returns to the processing in Step S3.

The pieces of processing in Steps S3 to S6 are repeatedly performed until the reception intensity of the portable key 112 is determined to be saturated in Step S4, or until the variable i is determined to be greater than the constant n in Step S6. Therefore, the measurement portions MA1 to MAn of the authentication request signal are transmitted with transmission intensities SA1 to SAn, respectively.

The transmission intensities SA1 to SAn are set according to a predetermined pattern. As described later, the portable key 112 determines whether the received authentication request signal is the normal signal based on whether a reception intensity pattern of the measurement portions MA1 to MAn are matched with a transmission intensity pattern.

A pattern example of the transmission intensities SA1 to SAn will be described below.

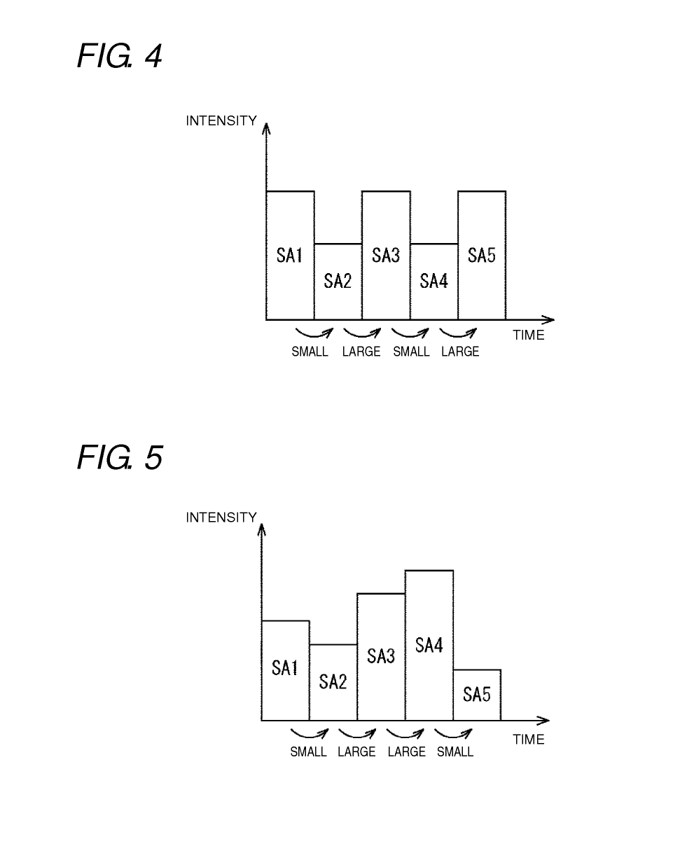

It is conceivable that, as a first example, the transmission intensities SA1 to SAn are set such that a change in transmission intensity between the measurement portions of the measuring signal in the authentication request signal has a predetermined pattern. In other words, it is conceivable that the transmission intensity of each measurement portion of the measuring signal in the authentication request signal is adjusted to change the transmission intensities SA1 to SAn such that the change in transmission intensity of the whole measuring signal has the predetermined pattern. FIGS. 4 and 5 illustrate pattern examples of the changes of the transmission intensities SA1 to SA5.

In the example in FIG. 4, the transmission intensity SA2 decreases compared with the preceding transmission intensity SA1, the transmission intensity SA3 increases compared with the preceding transmission intensity SA2, the transmission intensity SA4 decreases compared with the preceding transmission intensity SA3, and the transmission intensity SA5 increases compared with the preceding transmission intensity SA4. In this case, the transmission intensity pattern is recognized as a “small, large, small, and large” pattern. In the example in FIG. 5, the transmission intensity SA2 decreases compared with the preceding transmission intensity SA1, the transmission intensity SA3 increases compared with the preceding transmission intensity SA2, the transmission intensity SA4 increases compared with the preceding transmission intensity SA3, and the transmission intensity SA5 decreases compared with the preceding transmission intensity SA4. In this case, the transmission intensity pattern is recognized as a “small, large, large, and small” pattern.

In the first example, the value of the transmission intensity is no great significance as long as the pattern of the change in transmission intensity follows predetermined pattern. In the example in FIG. 4, by way of example, the transmission intensities SA1, SA3, and SA5 are set to the equal value and the transmission intensities SA2 and SA4 are set to the equal value. When the change in transmission intensity between the measurement portions adjacent to each other is correct, the transmission intensities SA1, SA3, and SA5 are not necessarily set to the equal value and the transmission intensities SA2 and SA4 are not necessarily set to the equal value. Specifically, for example, the transmission intensity SA3 may be set larger than the transmission intensities SA2 and SA4, and the transmission intensity SA3 may be set smaller than the transmission intensities SA1 and SA5.

In the above description, by way of example, the pattern of the change in transmission intensity is defined based on the preceding transmission intensity of the measurement portion. Alternatively, the pattern of the change in transmission intensity may be defined while the reference value is set to one value. For example, the transmission intensity SA1 of the head measurement portion MA1 may be set to the reference value, and the pattern of the change in transmission intensity may be defined based on whether the transmission intensity of the measurement portion MA2 or later is larger or smaller than the transmission intensity SA1.

It is conceivable that, as a second example, the transmission intensities SA1 to SAn are set such that not only the change in transmission intensity between the measurement portions of the measuring signal in the authentication request signal but also a change amount thereof have the predetermined patterns. In the example in FIG. 4, the change amount of the transmission intensity may be determined in addition to the change in transmission intensity between the measurement portions adjacent to each other. That is, the transmission intensity SA2 may be decreased by a predetermined change amount ΔSA1 compared with the preceding transmission intensity SA1, and the transmission intensity SA3 may be increased by a predetermined change amount ΔSA2 compared with the preceding transmission intensity SA2.

Also in the second example, the pattern of the change in transmission intensity and the pattern of the change amount may be defined while the reference value is set to one value. For example, the transmission intensity SA1 of the head measurement portion MA1 may be set to the reference value, and the patterns of the change in transmission intensity and change amount may be defined based on how much larger or smaller the transmission intensity of the measurement portion MA2 or later is than the transmission intensity SA1.

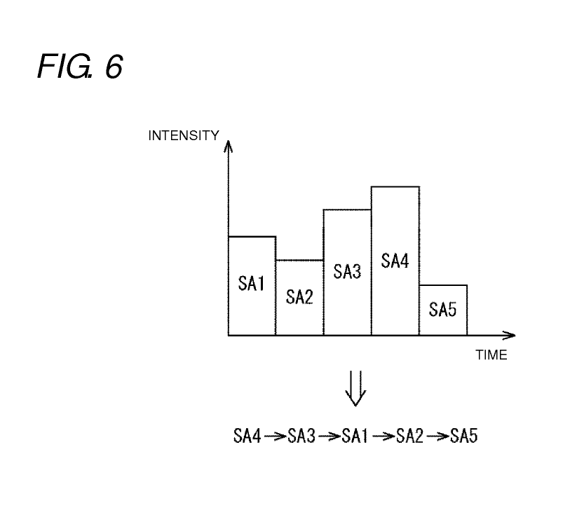

It is conceivable that, as a third example, the transmission intensities SA1 to SAn are set such that the order of the change in transmission intensity between the measurement portions of the measuring signal in the authentication request signal has the predetermined pattern. For example, as illustrated in FIG. 6, the transmission intensities SA1 to SA5 of the measurement portions MA1 to MA5 may be set so as to have the transmission intensities SA4, SA3, SA1, SA2, and SA5 in the descending order.

Referring to FIG. 2, when the variable i is determined to be greater than the constant n in Step S6, namely, when the transmission of all the measurement portions MA1 to MAn of the authentication request signal is completed, the authentication request signal transmitting processing is ended.

When the signal processor 134 notifies the transmission controller 135 that the reception intensity saturation notification signal is received in Step S4, the transmission controller 135 determines that the reception intensity of the portable key 112 is saturated, and the flow goes to processing in Step S7.

In Step S7, the transmission controller 135 wholly lowers the transmission intensity. For example, the transmission controller 135 sets the transmission intensities SA0 to SAn to the values wholly lowered from the present values.

The lowering range of the transmission intensity may be a previously-set fixed value or a variation corresponding to the reception intensity of the portable key 112. For the variation, the reception intensity saturation notification signal transmitted from the portable key 112 may include the measurement result of the reception intensity.

Then the flow returns to the processing in Step S1, and the pieces of processing from Step S1 are performed. That is, the authentication request signal is retransmitted with the transmission intensity lowered.

(First Embodiment of Authentication Request Signal Receiving Processing Performed by Portable Key 112)

A first embodiment of the authentication request signal receiving processing performed by the portable key 112 in response to the authentication request signal transmitting processing in FIG. 2 performed by the in-vehicle communication device 111 will be described with reference to a flowchart in FIG. 7. In the first embodiment, a reception intensity RAi is determined every time the portable key 112 receives the measurement portion MAi of the authentication request signal.

In Step S101, the portable key 112 receives the information signal of the authentication request signal. Specifically, the receiver 142 receives the information signal of the authentication request signal transmitted from the in-vehicle communication device 111 through the processing in Step S1 of FIG. 2 through the antenna 141, and demodulates the received authentication request signal. The receiver 142 supplies the demodulated authentication request signal to the signal processor 154 through the reception controller 151.

In Step S102, the signal processor 154 determines whether a signal content is normal. For example, when the authentication information on the in-vehicle communication device 111, which is included in the information signal of the received authentication request signal, is normal, and when a format and content of other piece of information are normal, the signal processor 154 determines that the signal content is normal, and the flow goes to the processing in Step S103.

In Step S103, the reception controller 151 sets the variable i to a value of 1.

In Step S104, the portable key 112 measures the reception intensity RAi. Specifically, the receiver 142 receives the measurement portion MAi of the authentication request signal transmitted from the in-vehicle communication device 111 through the processing in Step S3 of FIG. 2 through the antenna 141, and supplies the measurement portion MAi of the authentication request signal to the measurement part 152. The measurement part 152 measures RSSI (Received Signal Strength Indication) of the measurement portion MAi, and notifies the determination part 153 of the measurement result. The determination part 153 stores the notified measurement result as a reception intensity RAi.

In Step S105, the determination part 153 determines whether the reception intensity RAi is saturated. When the reception intensity RAi is less than a predetermined threshold, the determination part 153 determines that the reception intensity RAi is not saturated, and the flow goes to the processing in Step S106.

In Step S106, the determination part 153 determines whether the reception intensity RAi is normal. That is, the determination part 153 determines whether the reception intensity RAi is normal based on whether the reception intensity RAi of the measurement portion MAi is matched with the pattern of the transmission intensity.

For example, like the first example, it is assumed that the transmission intensities SA1 to SAn are set such that the change in transmission intensity has the predetermined pattern. For example, in the case that the transmission intensity SAi is set so as to be larger than the preceding transmission intensity SA(i−1), the determination part 153 determines that the reception intensity RAi is normal because the reception intensity RAi is matched with the pattern of the transmission intensity when the reception intensity RAi is greater than the reception intensity RA(i−1)+TH1. The reception intensity RA(i−1) is the preceding reception intensity of the reception intensity RAi, and TH1 is the predetermined threshold.

On the other hand, the determination part 153 determines that the reception intensity RAi is abnormal because the reception intensity RAi is not matched with the pattern of the transmission intensity when the reception intensity RAi is less than or equal to the reception intensity RA(i−1)+TH1.

In the case that the change in transmission intensity is defined based on the predetermined one reference value, for example, the reception-side reference value (for example, reception intensity RA1) corresponding to the transmission-side reference value (for example, transmission intensity SA1) is used instead of the reception intensity RA(i−1) in the determination expression.

For example, like the second example, it is assumed that the transmission intensities SA1 to SAn are set such that the change in transmission intensity and the change amount have the predetermined patterns. For example, in the case that the transmission intensity SAi is set so as to be larger than the preceding transmission intensity SA(i−1) by ΔSA, the determination part 153 determines that the reception intensity RAi is normal because the reception intensity RAi is matched with the pattern of the transmission intensity when the reception intensity RAi is greater than the reception intensity RA(i−1) and when |ΔSA−ΔRA| is less than or equal to TH2. Note that ΔRA=RAi−RA(i−1) holds and TH2 is the predetermined threshold. That is, the reception intensity RAi is determined to be normal when a change amount ΔRA between the reception intensity RAi and the reception intensity RA(i−1) is substantially equal to the change amount ΔSA between the transmission intensity SAi and the transmission intensity SA(i−1).

On the other hand, the determination part 153 determines that the reception intensity RAi is abnormal because the reception intensity RAi is not matched with the pattern of the transmission intensity when the reception intensity RAi is less than or equal to the reception intensity RA(i−1) or when |ΔSA−ΔRA| is greater than TH2.

In the case that the change in transmission intensity and the change amount are defined based on the predetermined one reference value, for example, the reception-side reference value (for example, reception intensity RA1) corresponding to the transmission-side reference value (for example, transmission intensity SA1) is used instead of the reception intensity RA(i−1) in the determination expression.

In the case that the transmission intensities SA1 to SAn are set such that the order of the transmission intensity has the predetermined pattern like the third example, the reception intensity is determined by not this processing but the authentication request signal receiving processing in FIG. 8.

When the reception intensity RAi is determined to be normal, the flow goes to the processing in Step S107.

The pattern of the transmission intensities SA1 to SAn, which serves as a criterion, may previously be stored in the portable key 112, or the in-vehicle communication device 111 may make the notification of the pattern of the transmission intensities SA1 to SAn. In the latter case, for example, the in-vehicle communication device 111 may notify the portable key 112 of the information signal of the authentication request signal while the information on the setting pattern of the transmission intensities SA1 to SAn is included in the information signal content of the authentication request signal. The pattern of the transmission intensities SA1 to SAn can be changed in each communication by making the notification of the pattern of the transmission intensities SA1 to SAn, and the relay attack may be difficult to perform.

In Step S107, the reception controller 151 increments the value of the variable i by one.

In Step S108, the reception controller 151 determines whether the variable i is greater than the constant n. When the variable i is determined to be less than or equal to the constant n, the flow returns to the processing in Step S104.

Then, the pieces of processing in Steps S104 to S108 are repeatedly performed until the reception intensity RAi is determined to be saturated in Step S105, until the reception intensity RAi is determined to be abnormal in Step S106, or until the variable i is determined to be greater than the constant n in Step S108.

Therefore, the measurement portions MA1 to MAn of the authentication request signal are received to measure and determine the reception intensities RA1 to RAn of the measurement portions MA1 to MAn. Whether the pattern of the reception intensities RA1 to RAn is matched with the pattern of the transmission intensities SA1 to SAn is determined by sequentially performing the determination processing to the reception intensities RA1 to RAn.

On the other hand, when the variable i is determined to be greater than the constant n in Step S108, the flow goes to the processing in Step S109.

In Step S109, the determination part 153 determines that the normal authentication request signal is received. That is, the determination part 153 determines that the normal authentication request signal is received when the information signal content is normal, and the pattern of the reception intensities RA1 to RAn is matched with the pattern of the transmission intensities SA1 to SAn. The determination part 153 notifies the signal processor 154 that normal authentication request signal is received.

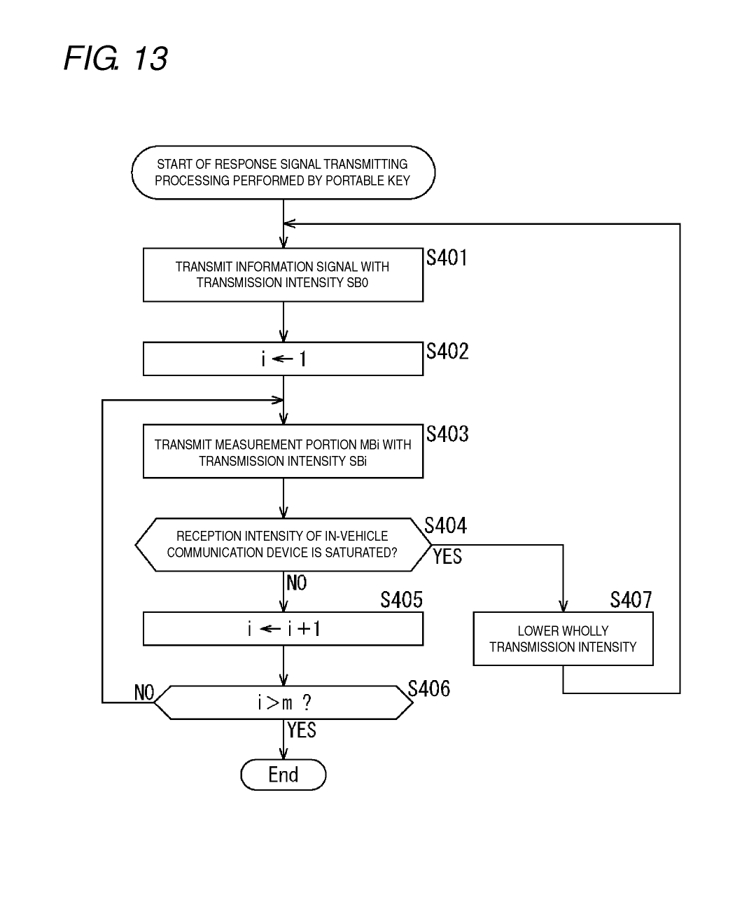

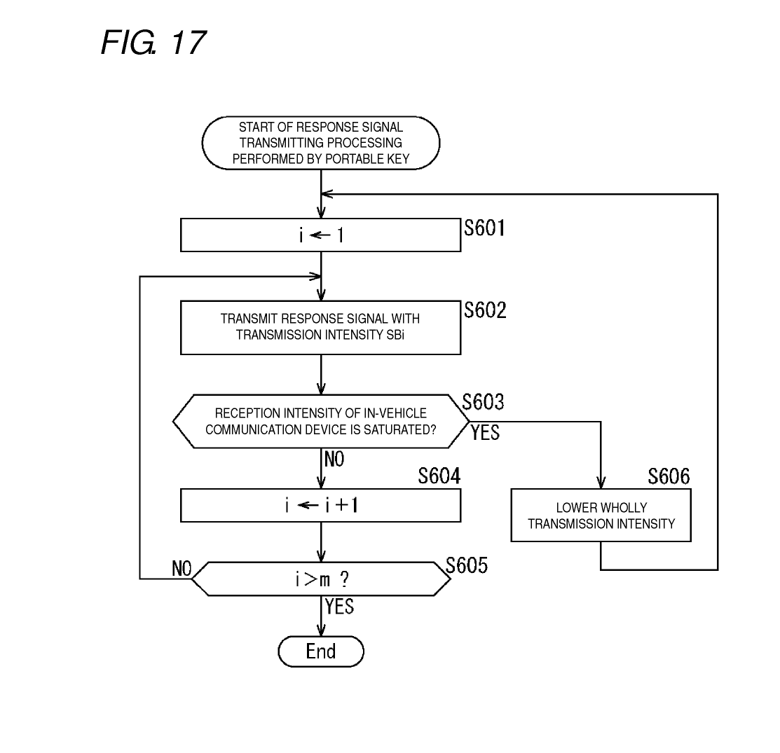

In Step S110, the portable key 112 performs the response signal transmitting processing. The detailed response signal transmitting processing is described later with reference to flowcharts in FIGS. 13 and 17. Through the response signal transmitting processing, the portable key 112 transmits the response signal to the in-vehicle communication device 111. In the case that the in-vehicle communication device 111 receives the normal response signal, predetermined processing (for example, the pieces of processing such as the automatic entry function, the push start function, and the welcome lamp lighting function) of the vehicle 102 is performed.

Then the authentication request signal receiving processing is ended.

On the other hand, when the reception intensity RAi is determined to be abnormal in Step S106, the pieces of processing in Steps S107 to S110 are skipped, and the authentication request signal receiving processing is ended without performing the response signal transmitting processing.

When the reception intensity RAi is determined to be saturated in Step S105, the flow goes to the processing in Step S111.

In Step S111, the portable key 112 makes notification that the reception intensity is saturated. Specifically, the determination part 153 notifies the signal processor 154 that the reception intensity RAi is saturated. The signal processor 154 generates the reception intensity saturation notification signal, and supplies the reception intensity saturation notification signal to the transmitter 145 through the transmission controller 155. As described above, the reception intensity saturation notification signal may include the measurement result of the reception intensity. Under the control of the transmission controller 155, the transmitter 145 FSK-modulates the reception intensity saturation notification signal, and transmits the modulated reception intensity saturation notification signal through the antenna 146.

Then the flow returns to the processing in Step S101, and the pieces of processing from Step S101 are performed. That is, the authentication request signal that is transmitted from the in-vehicle communication device 111 with the transmission intensity lowered is received again.

When the authentication information on the in-vehicle communication device 111, which is included in the information signal of the received authentication request signal, is not normal information in Step S102, or when the format or content of other piece of information are abnormal, for example, the signal processor 154 determines that the signal content is abnormal. Then, the pieces of processing in Steps S103 to S110 are skipped, and the authentication request signal receiving processing is ended without performing the response signal transmitting processing.

The response signal is not transmitted from the portable key 112 in the case that the pattern of the reception intensities RA1 to RAn of the measurement portions MA1 to MAn in the authentication request signal is not matched with the pattern of the transmission intensities SA1 to SAn in addition to the case that the contents of the authentication request signal is abnormal. On the other hand, for the repeater 104, it is difficult to rapidly and correctly reproduce the change in transmission intensity of the measurement portions MA1 to MAn in the authentication request signal to transfer the signal. Accordingly, the relay attack may be difficult to perform.

In the case that the reception intensity is saturated, the authentication request signal is retransmitted with the transmission intensity lowered. Accordingly, for example, the false determination that the authentication request signal is abnormal due to the saturation of the reception intensity can be prevented in the case that the distance between the vehicle 102 and the portable key 112 is short and the reception intensity is increased.

As illustrated in FIGS. 4 and 5, in the case that the transmission intensities SA1 to SAn are set such that the change in transmission intensity has the predetermined pattern, necessity of the strict determination of the reception intensity value is eliminated when only the change in reception intensity can be determined. Accordingly, for example, the false detection of the pattern of the reception intensities RA1 to RAn due to the variation in reception intensity by a noise and the like can be prevented.

(Second Embodiment of Authentication Request Signal Receiving Processing Performed by Portable Key 112)

A second embodiment of the authentication request signal receiving processing performed by the portable key 112 in response to the authentication request signal transmitting processing in FIG. 2 performed by the in-vehicle communication device 111 will be described with reference to a flowchart in FIG. 8.

The flowchart in FIG. 8 differs from the flowchart in FIG. 7 only in a position of the reception intensity determination processing. In the flowchart in FIG. 7, the reception intensity RAi of the measurement portion MAi is determined in Step S106 every time the measurement portion MAi of the authentication request signal is received. On the other hand, in the flowchart in FIG. 8, whether the reception intensities RA1 to RAn of the measurement portions MA1 to MAn are normal as a whole is determined in Step S158 after all the measurement portions MA1 to MAn are received.

For example, in the case that the order of the transmission intensities SA1 to SAn is set to the predetermined pattern as illustrated in FIG. 6, whether the reception intensities RA1 to RAn are matched with the predetermined pattern can be determined only after all the reception intensities RA1 to RAn of the measurement portions MA1 to MAn are measured. In this case, the reception intensities RA1 to RAn can be determined through the processing of the flowchart in FIG. 8.

The processing of the flowchart in FIG. 8 can also be applied in the case that the change of the transmission intensities SA1 to SAn is set to the predetermined pattern or in the case that the change of the transmission intensities SA1 to SAn and the change amount are set to the predetermined patterns.

When the reception intensity is determined to be normal in Step S158, the flow goes to the processing in Step S159. The normal authentication request signal is determined to be received in Step S159 similarly to the processing in Step S109 of FIG. 7, and the response signal transmitting processing is performed in Step S160 similarly to the processing in Step S110 of FIG. 7. Then the authentication request signal receiving processing is ended. On the other hand, when the reception intensity is determined to be abnormal in Step S158, the pieces of processing in Steps S159 and S160 are skipped, and the authentication request signal receiving processing is ended without performing the response signal transmitting processing.

(Second Embodiment of Authentication Request Signal Transmitting Processing Performed by in-Vehicle Communication Device 111)

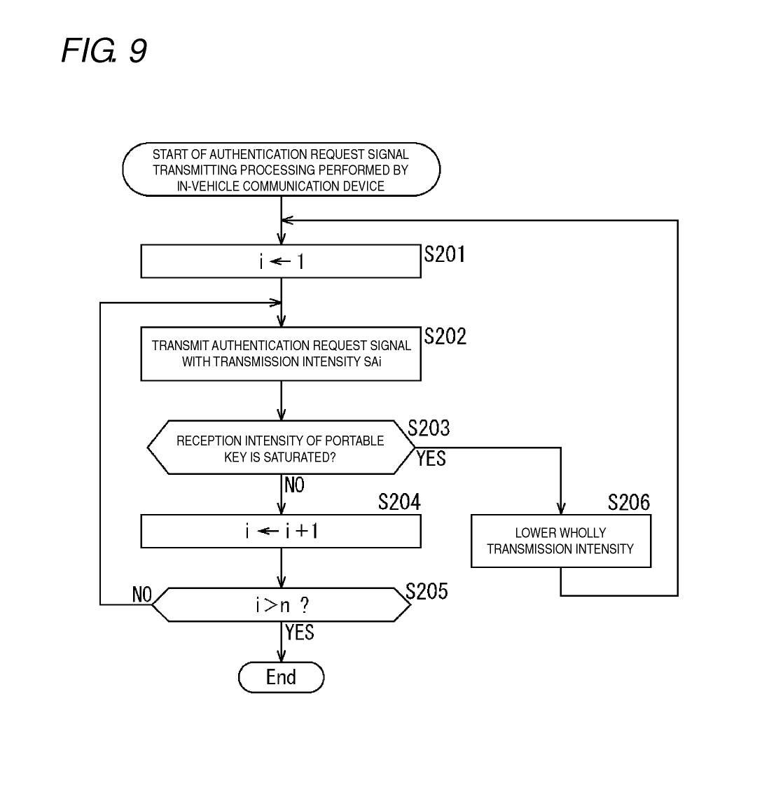

A second embodiment of the authentication request signal transmitting processing performed by the in-vehicle communication device 111 will be described with reference to a flowchart in FIG. 9. In the second embodiment, instead of changing the transmission intensity of the measuring signal in the authentication request signal, the authentication request signal is transmitted predetermined times, and the transmission intensity of each authentication request signal is changed according to the predetermined pattern.

For example, the processing of the communication system 101 is performed when the predetermined operation (for example, the user operates the button provided in the door of the vehicle 102) is performed to the operation part 103 of the vehicle 102, or the processing is periodically performed.

In Step S201, similarly to the processing in Step S2 of FIG. 2, the variable i is set to the value of 1.

In Step S202, the in-vehicle communication device 111 transmits the authentication request signal with the transmission intensity SAi. Specifically, the signal processor 134 generates the authentication request signal, and supplies the authentication request signal to the transmitter 124 through the transmission controller 135. Under the control of the transmission controller 135, the transmitter 124 ASK-modulates the authentication request signal, and transmits the modulated authentication request signal through the antenna 125 with the transmission intensity SAi. Note that the measuring signal (FIG. 3) is not necessarily added to the authentication request signal.

In Step S203, whether the reception intensity of the portable key 112 is saturated is determined similarly to the processing in Step S4 of FIG. 2. When the reception intensity of the portable key 112 is determined to be not saturated, flow goes to the processing in Step S204.

In Step S204, the value of the variable i is incremented by 1 similarly to the processing in Step S5 of FIG. 2.

In Step S205, whether the variable i is greater than the constant n is determined similarly to the processing in Step S6 of FIG. 2. When the variable i is determined to be less than or equal to the constant n, the flow returns to the processing in Step S202.

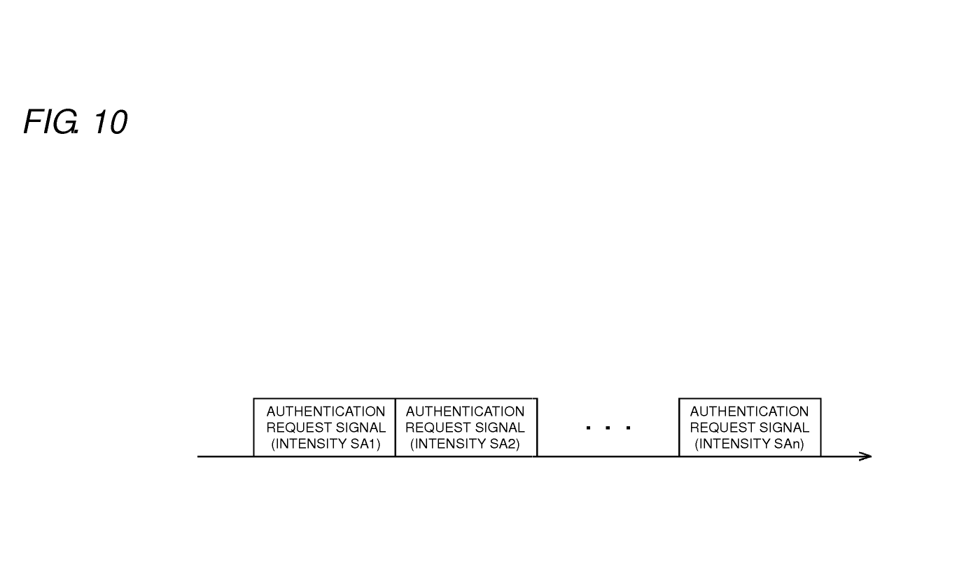

The pieces of processing in Steps S202 to S205 are repeatedly performed until the reception intensity of the portable key 112 is determined to be saturated in Step S203, or until the variable i is determined to be greater than the constant n in Step S205. Therefore, as illustrated in FIG. 10, the authentication request signal is repeatedly transmitted n times with the transmission intensities SA1 to SAn.

The pattern similar to that of the transmission intensity of the measurement portion of the measuring signal in the authentication request signal can be used as the pattern of the transmission intensity of the authentication request signal.

When the variable i is determined to be greater than the constant n in Step S205, namely, when the authentication request signal is transmitted n times, the authentication request signal transmitting processing is ended.

When the reception intensity of the portable key 112 is determined to be saturated in Step S203, the flow goes to the processing in Step S206.

In Step S206, the transmission controller 135 wholly lowers the transmission intensity. Specifically, transmission controller 135 sets the transmission intensities SA1 to SAn to the values wholly lowered from the present values similarly to the processing in Step S7 of FIG. 2.

Then the flow returns to the processing in Step S201, and the pieces of processing from Step S201 are performed. The n-time transmission of the authentication request signal is performed again from the beginning while the transmission intensity is lowered.

(Third Embodiment of Authentication Request Signal Receiving Processing Performed by Portable Key 112)

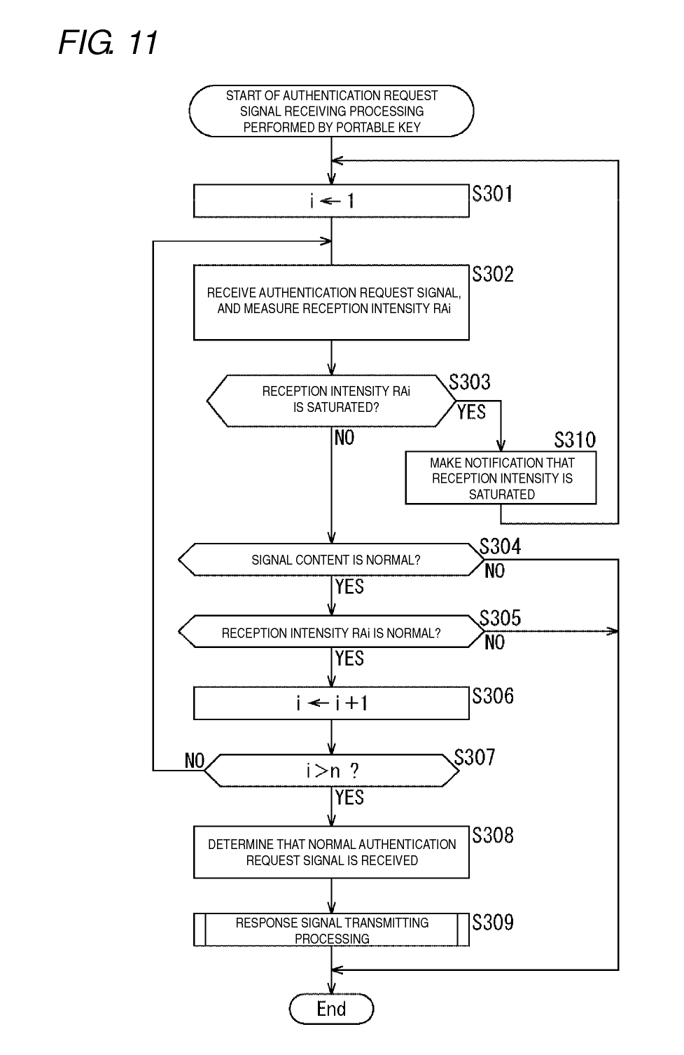

A third embodiment of the authentication request signal receiving processing performed by the portable key 112 in response to the authentication request signal transmitting processing in FIG. 9 performed by the in-vehicle communication device 111 will be described with reference to a flowchart in FIG. 11. In the third embodiment, the reception intensity RAi of the authentication request signal is determined every time the portable key 112 receives the authentication request signal.

In Step S301, similarly to the processing in Step S103 of FIG. 7, the variable is set to the value of 1.

In Step S302, the portable key 112 measures the reception intensity RAi while receiving the authentication request signal. Specifically, the receiver 142 receives the authentication request signal transmitted from the in-vehicle communication device 111 through the processing in Step S202 of FIG. 9 through the antenna 141, and demodulates the received authentication request signal. The receiver 142 supplies the demodulated authentication request signal to the signal processor 154 through the reception controller 151.

The receiver 142 supplies the pre-demodulation authentication request signal to the measurement part 152. The measurement part 152 measures the RSSI of the authentication request signal, and notifies the determination part 153 of the measurement result. The determination part 153 stores the notified measurement result as a reception intensity RAi.

In Step S303, whether the reception intensity RAi is saturated is determined similarly to the processing in Step S105 of FIG. 7. When the reception intensity RAi is determined to be not saturated, flow goes to the processing in Step S304.

In Step S304, whether the content of the signal is normal is determined similarly to the processing in Step S102 of FIG. 7. When the signal content is determined to be normal, the flow goes to the processing in Step S305.

In Step S305, whether the reception intensity RAi is normal is determined similarly to the processing in Step S106 of FIG. 7. When the reception intensity RAi is determined to be normal, the flow goes to the processing in Step S306.

Similarly to the first embodiment of the authentication request signal receiving processing in FIG. 7, the pattern of the transmission intensities SA1 to SAn, which serves as the criterion, may previously be stored in the portable key 112, or the in-vehicle communication device 111 may make the notification of the pattern of the transmission intensities SA1 to SAn. In the latter case, for example, the in-vehicle communication device 111 may notify the portable key 112 of the information signal of the authentication request signal while the information on the setting pattern of the transmission intensities SA1 to SAn is included in the content of the authentication request signal. Note that the information on the setting pattern of the transmission intensities SA1 to SAn may be included in one of the authentication request signals transmitted n times, or included in all the authentication request signals.

In Step S306, similarly to the processing in Step S107 of FIG. 7, the value of the variable i is incremented by 1.

In Step S307, whether the variable i is greater than the constant n is determined similarly to the processing in Step S108 of FIG. 7. When the variable i is determined to be less than or equal to the constant n, the flow returns to the processing in Step S302.

Then, the pieces of processing in Steps S302 to S307 are repeatedly performed until the reception intensity RAi is determined to be saturated in Step S303, until the signal content is determined to be abnormal in Step S304, until the reception intensity RAi is determined to be abnormal in Step S305, or until the variable i is determined to be greater than the constant n in Step S307. Therefore, the authentication request signal is received n times, and the reception intensity of each authentication request signal is measured and determined.

On the other hand, when the variable i is determined to be greater than the constant n in Step S307, the flow goes to the processing in Step S308.

In Step S308, the determination part 153 determines that the normal authentication request signal is received. That is, the determination part 153 determines that the normal authentication request signal is received when the authentication request signal content is normal, and the pattern of the reception intensities RA1 to RAn is matched with the pattern of the transmission intensities SA1 to SAn. The determination part 153 notifies the signal processor 154 that normal authentication request signal is received.

In Step S309, the response signal transmitting processing is performed similarly to the processing in Step S110 of FIG. 7. Then the authentication request signal receiving processing is ended.

On the other hand, when the reception intensity RAi is determined to be abnormal in Step S305, the pieces of processing in Steps S306 to S309 are skipped, and the authentication request signal receiving processing is ended without performing the response signal transmitting processing.

When the signal content is determined to be abnormal in Step S304, the pieces of processing in Steps S305 to S309 are skipped, and the authentication request signal receiving processing is ended without performing the response signal transmitting processing.

When the reception intensity RAi is determined to be saturated in Step S303, the flow goes to the processing in Step S310.

In Step S310, similarly to the processing in Step S111 of FIG. 7, the in-vehicle communication device 111 is notified that the reception intensity is saturated.

Then, the flow returns to the processing in Step S301, and the pieces of processing from Step S301 are performed. That is, the authentication request signal that is transmitted n times with the transmission intensity lowered is received again from the in-vehicle communication device 111.

As described above, the effect similar to the case that the portable key 112 determines the reception intensity while the in-vehicle communication device 111 transmits the measuring signal of the authentication request signal with the predetermined pattern of the transmission intensity can be obtained, even in the case that the portable key 112 determines the reception intensity while the in-vehicle communication device 111 transmits the authentication request signal n times with the predetermined pattern of the transmission intensity.

(Fourth Embodiment of Authentication Request Signal Receiving Processing Performed by Portable Key 112)

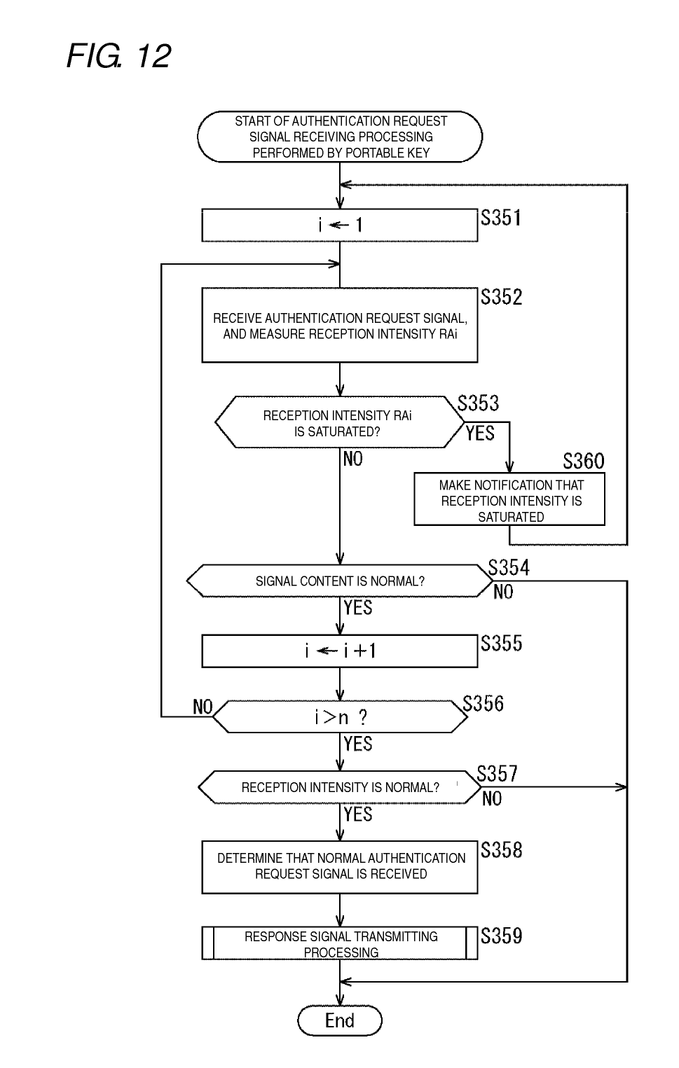

A fourth embodiment of the authentication request signal receiving processing performed by the portable key 112 in response to the authentication request signal transmitting processing in FIG. 9 performed by the in-vehicle communication device 111 will be described below with reference to a flowchart in FIG. 12.

The flowchart in FIG. 12 differs from the flowchart in FIG. 11 only in the position of the reception intensity determination processing. That is, in the flowchart in FIG. 11, whether the reception intensity RAi of the authentication request signal is normal is determined in Step S305 every time the authentication request signal is received. On the other hand, in the flowchart in FIG. 12, similarly to the second embodiment of the authentication request signal receiving processing in FIG. 8, whether the reception intensities RA1 to RAn of the n-time authentication request signal are normal as a whole is determined in Step S357 after the authentication request signal is received n times.

When the reception intensity is determined to be normal in Step S357, the flow goes to the processing in Step S358. The normal authentication request signal is determined to be received in Step S358 similarly to the processing in Step S308 of FIG. 11, and the response signal transmitting processing is performed in Step S359 similarly to the processing in Step S110 of FIG. 7. Then the authentication request signal receiving processing is ended. On the other hand, when the reception intensity is determined to be abnormal in Step S358, the pieces of processing in Steps S358 and S359 are skipped, and the authentication request signal receiving processing is ended without performing the response signal transmitting processing.

[Response Signal Transmitting and Receiving Processing]

The pieces of processing in which the portable key 112 that receives the authentication request signal transmits the response signal and the in-vehicle communication device 111 that receives the response signal performs processing corresponding to the received response signal will be described below with reference to FIGS. 13 to 20.

(First Embodiment of Response Signal Transmitting Processing Performed by in-Vehicle Communication Device 111)

A first embodiment of the response signal transmitting processing performed in Step S110 of FIG. 7, Step S160 of FIG. 8, Step S309 of FIG. 11, or Step S359 of FIG. 12 will be described with reference to a flowchart in FIG. 13.

In Step S401, the portable key 112 transmits the information signal of the response signal with a transmission intensity SB0.

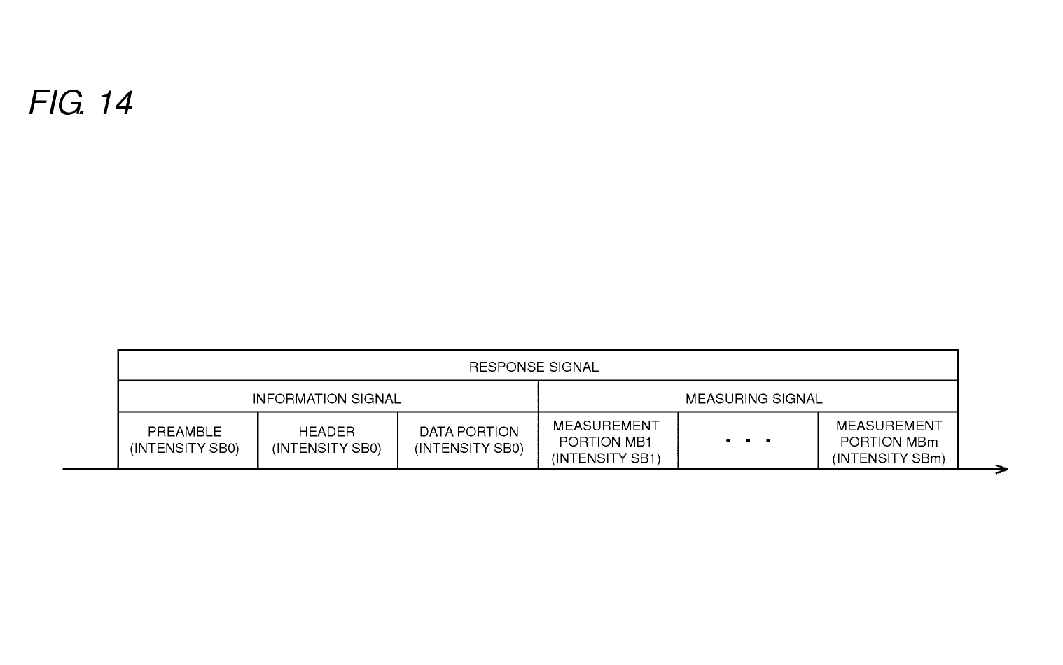

A configuration example of the response signal will be described with reference to FIG. 14.

The response signal is roughly divided into two blocks, namely, the information signal including data necessary for the actual processing and the measuring signal used to measure the reception intensity in the in-vehicle communication device 111. The information signal is divided into three blocks of a preamble, a header, and a data portion.

For example, the preamble is the block that includes a synchronous code having a predetermined value in order to synchronize the in-vehicle communication device 111 and the portable key 112 with each other.

The header is the block that includes data of the signal, such as the kind and the length, which is related to the response signal.

The data portion is the block that includes data necessary for the processing of the in-vehicle communication device 111. For example, the data portion includes authentication information, such as ID, which identifies the portable key 112, and a command to the vehicle 102 to perform predetermined processing.

For example, the measuring signal is the CW (Continuous Wave) signal, and is divided into m blocks of measurement portions MB1 to MBm. Desirably the value of m is set to 3 or a greater value.

As described later, the information signal (the preamble, the header, and the data portion) is transmitted with the transmission intensity SB0. By the method similar to that for the measurement portions MA1 to MAn of the authentication request signal, the measurement portions MB1 to MBm are transmitted with transmission intensities SB1 to SBm, respectively.

The signal processor 154 generates the response signal, and supplies the response signal to the transmitter 145 through the transmission controller 155. Under the control of the transmission controller 155, the transmitter 145 FSK-modulates the information signal of the response signal, and transmits the modulated information signal through the antenna 146 with the transmission intensity SB0.

In Step S402, the transmission controller 155 sets the variable i to the value of 1.

In Step S403, under the control of the transmission controller 155, the transmitter 145 transmits the measurement portion MBi of the measuring signal of the response signal through the antenna 146 with the transmission intensity SBi.

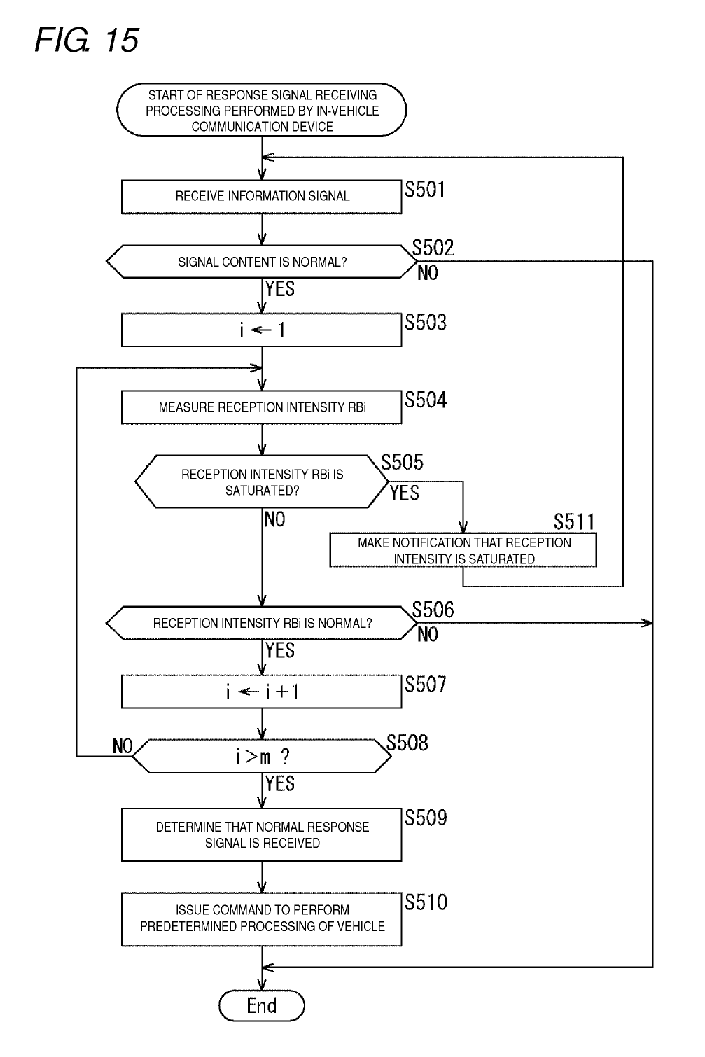

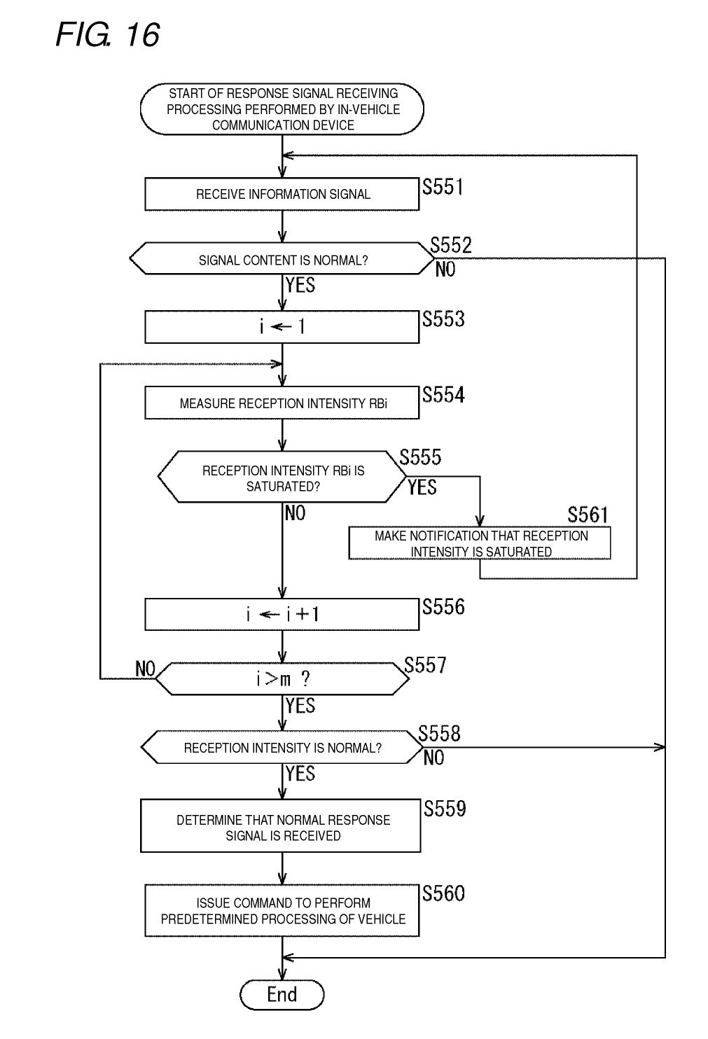

In Step S404, the transmission controller 155 determines whether the reception intensity of the in-vehicle communication device 111 is saturated. Specifically, when the reception intensity of the response signal transmitted from the portable key 112 is saturated, the in-vehicle communication device 111 transmits the reception intensity saturation notification signal in order to make the notification that the reception intensity is saturated in Step S511 of FIG. 15 or Step S561 of FIG. 16. When receiving the reception intensity saturation notification signal transmitted from the in-vehicle communication device 111 through the antenna 141, the receiver 142 supplies the reception intensity saturation notification signal to the signal processor 154 through the reception controller 151. The signal processor 154 notifies the transmission controller 155 that the reception intensity saturation notification signal is received.

Unless the transmission controller 155 receives the notification that the reception intensity saturation notification signal is received from the signal processor 154, the transmission controller 155 determines that the reception intensity of the in-vehicle communication device 111 is not saturated, and the flow goes to the processing in Step S405.

In Step S405, the transmission controller 155 increments the value of the variable i by 1.

In Step S406, the transmission controller 155 determines whether the variable i is greater than a constant m. When the variable i is determined to be less than or equal to the constant m, the flow returns to the processing in Step S403.

The pieces of processing in Steps S403 to S406 are repeatedly performed until the reception intensity of the in-vehicle communication device 111 is determined to be saturated in Step S404, or until the variable i is determined to be greater than the constant m in Step S406. Therefore, the measurement portions MB1 to MBm of the response signal are transmitted with transmission intensities SB1 to SBm, respectively.

The pattern similar to that of the transmission intensities SA1 to SAn of the measurement portions MA1 to MAn of the authentication request signal can be used as the pattern of the transmission intensities SB1 to SBm of the measurement portions MB1 to MBm of the response signal.

On the other hand, when the variable i is determined to be greater than the constant m in Step S406, namely, when the transmission of all the measurement portions MB1 to MBm of the response signal is completed, the response signal transmitting processing is ended.

When the signal processor 154 notifies the transmission controller 155 that the reception intensity saturation notification signal is received in Step S404, the transmission controller 155 determines that the reception intensity of the in-vehicle communication device 111 is saturated, and the flow goes to the processing in Step S407.

In Step S407, the transmission controller 155 wholly lowers the transmission intensity. For example, the transmission controller 155 sets the transmission intensities SB0 to SBm to the values wholly lowered from the present values.

The lowering range of the transmission intensity may be the previously-set fixed value or the variation corresponding to the reception intensity of the in-vehicle communication device 111. For the variation, the reception intensity saturation notification signal transmitted from the in-vehicle communication device 111 may include the information indicating the reception intensity.

Then the flow returns to the processing in Step S401, and the pieces of processing from Step S401 are performed. That is, the response signal is retransmitted with the transmission intensity lowered.

(First Embodiment of Response Signal Receiving Processing Performed by in-Vehicle Communication Device 111)

A first embodiment of the response signal receiving processing performed by the in-vehicle communication device 111 in response to the response signal transmitting processing in FIG. 13 performed by the portable key 112 will be described below with reference to a flowchart in FIG. 15. In the first embodiment, the reception intensity RBi of the measurement portion MBi is determined every time the in-vehicle communication device 111 receives the measurement portion MBi of the response signal.

In Step S501, the in-vehicle communication device 111 receives the information signal of the response signal. Specifically, the receiver 122 receives the information signal of the response signal transmitted from the portable key 112 through the processing in Step S401 of FIG. 13 through the antenna 121, and demodulates the received response signal. The receiver 122 supplies the demodulated response signal to the signal processor 134 through the reception controller 131.

In Step S502, the signal processor 134 determines whether the signal content is normal. For example, when the authentication information on the portable key 112, which is included in the information signal of the received response signal, is normal, and when the format and content of other piece of information are normal, the signal processor 134 determines that the signal content is normal, and the flow goes to the processing in Step S503.

In Step S503, the reception controller 131 sets the variable i to the value of 1.

In Step S504, the in-vehicle communication device 111 measures the reception intensity RBi. Specifically, the receiver 122 receives the measurement portion MBi of the response signal transmitted from the portable key 112 through the processing in Step S403 of FIG. 13 through the antenna 121, and supplies the measurement portion MBi of the response signal to the measurement part 132. The measurement part 132 measures the RSSI of the measurement portion MBi, and notifies the determination part 133 of the measurement result. The determination part 133 stores the notified measurement result as the reception intensity RBi.

In Step S505, the determination part 133 determines whether the reception intensity RBi is saturated. When the reception intensity RBi is less than a predetermined threshold, the determination part 133 determines that the reception intensity RBi is not saturated, and the flow goes to the processing in Step S506.

In Step S506, the determination part 133 determines whether the reception intensity RBi is normal. That is, the reception intensity RBi is determined by the method similar to the processing of determining the reception intensity RAi in the portable key 112 in Step S106 of FIG. 7. When the reception intensity RBi is determined to be normal, the flow goes to the processing in Step S507.

In Step S507, the reception controller 131 increments the value of the variable i by 1.

In Step S508, the reception controller 131 determines whether the variable i is greater than the constant m. When the variable i is determined to be less than or equal to the constant m, the flow returns to the processing in Step S504.

The pieces of processing in Steps S504 to S508 are repeatedly performed until the reception intensity RBi is determined to be saturated in Step S505, until the reception intensity RBi is determined to be abnormal in Step S506, or until the variable i is determined to be greater than the constant m in Step S508.

Therefore, the measurement portions MB1 to MBm of the response signal are received to measure and determine the reception intensities RB1 to RBm of the measurement portions MB1 to MBm. Whether the pattern of the reception intensities RB1 to RBm is matched with the pattern of the transmission intensities SB1 to SBm is determined by sequentially performing the determination processing to the reception intensities RB1 to RBm.

On the other hand, when the variable i is determined to be greater than the constant m in Step S508, the flow goes to the processing in Step S509.

In Step S509, the determination part 133 determines that the normal response signal is received. That is, the determination part 133 determines that the normal response signal is received when the information signal content is normal, and the pattern of the reception intensities RB1 to RBm is matched with the pattern of the transmission intensities SB1 to SBm. The determination part 133 notifies the signal processor 134 that the normal response signal is received.

In Step S510, the vehicle controller 136 issues a command to perform the predetermined processing of the vehicle 102. Specifically, the signal processor 134 supplies the command included in the data portion of the information signal of the response signal to the vehicle controller 136. The vehicle controller 136 issues the command to another device such as the ECU in the vehicle 102 to perform the processing corresponding to the acquired command. Therefore, the processing such as the automatic entry function, the push start function, and the welcome lamp lighting function is performed.

Then the response signal receiving processing is ended.

On the other hand, when the reception intensity RBi is determined to be abnormal in Step S506, the pieces of processing in Steps S507 to S510 are skipped, and the response signal receiving processing is ended without issuing the command to perform the predetermined processing of the vehicle 102.

When the reception intensity RBi is determined to be saturated in Step S505, the flow goes to the processing in Step S511.

In Step S511, the in-vehicle communication device 111 makes the notification that the reception intensity is saturated. Specifically, the determination part 133 notifies the signal processor 134 that the reception intensity RBi is saturated. The signal processor 134 generates the reception intensity saturation notification signal, and supplies the reception intensity saturation notification signal to the transmitter 124 through the transmission controller 135. As described above, the reception intensity saturation notification signal may include the measurement result of the reception intensity. Under the control of the transmission controller 135, the transmitter 124 ASK-modulates the reception intensity saturation notification signal, and transmits the modulated reception intensity saturation notification signal through the antenna 125.

Then, the flow returns to the processing in Step S501, and the pieces of processing from Step S501 are performed. That is, the response signal that is transmitted from the portable key 112 with the transmission intensity lowered is received again.

When the authentication information on the portable key 112, which is included in the information signal of the received response signal, is not the normal information in Step S502, or when the format or content of other piece of information are abnormal, for example, the signal processor 134 determines that the signal content is abnormal. Then, the pieces of processing in Steps S503 to S510 are skipped, and the response signal receiving processing is ended without issuing the command to perform the predetermined processing of the vehicle 102.

As described above, the predetermined processing of the vehicle 102 is not performed in the case that the pattern of the reception intensities RB1 to RBm of the measurement portions MB1 to MBm of the response signal is not matched with the pattern of the transmission intensities SB1 to SBm in addition to the case that the response signal content is abnormal. On the other hand, for the repeater 104, it is difficult to rapidly and correctly reproduce the change in transmission intensity of the measurement portions MB1 to MBm in the response signal to transfer the signal. Accordingly, the relay attack may be difficult to perform.

In the case that the reception intensity is saturated, the response signal is retransmitted with the transmission intensity lowered. Accordingly, for example, the false determination that the response signal is abnormal due to the saturation of the reception intensity can be prevented in the case that the distance between the vehicle 102 and the portable key 112 is short and the reception intensity is increased.

Similarly to the cases in FIGS. 4 and 5, in the case that the transmission intensities SB1 to SBm are set such that the change in transmission intensity has the predetermined pattern, the necessity of the strict determination of the reception intensity value is eliminated when only the change in reception intensity can be determined. Accordingly, for example, the false detection of the pattern of the reception intensities RB1 to RBm due to the variation in reception intensity by the noise can be prevented.

(Second Embodiment of Response Signal Receiving Processing Performed by in-Vehicle Communication Device 111)

A second embodiment of the response signal receiving processing performed by the in-vehicle communication device 111 in response to the response signal transmitting processing in FIG. 13 performed by the portable key 112 will be described below with reference to a flowchart in FIG. 16.

The flowchart in FIG. 16 differs from the flowchart in FIG. 15 only in the position of the reception intensity determination processing. That is, in the flowchart in FIG. 15, the reception intensity RBi of the measurement portion MBi is determined in Step S506 every time the measurement portion MBi of the response signal is received. On the other hand, in the flowchart in FIG. 16, whether the reception intensities RB1 to RBm of the measurement portions MB1 to MBm are normal as a whole is determined in Step S558 after all the measurement portions MB1 to MBm are received.

When the reception intensity is determined to be normal in Step S558, the flow goes to the processing in Step S559. The normal response signal is determined to be received in Step S559 similarly to the processing in Step S509 of FIG. 15, and the command to perform the predetermined processing of the vehicle 102 is issued in Step S560 similarly to the processing in Step S510 of FIG. 15. Then the response signal receiving processing is ended. On the other hand, when the reception intensity is determined to be abnormal in Step S558, the pieces of processing in Steps S559 and S560 are skipped, and the response signal receiving processing is ended without issuing the command to perform the predetermined processing of the vehicle 102.

(Second Embodiment of Response Signal Transmitting Processing Performed by Portable Key 112)

A second embodiment of the response signal transmitting processing performed by the portable key 112 will be described below with reference to a flowchart in FIG. 17. In the second embodiment, instead of changing the transmission intensity of the measuring signal in the response signal, the response signal is transmitted predetermined times, and the transmission intensity of each response signal is changed according to the predetermined pattern.

In Step S601, similarly to the processing in Step S402 of FIG. 13, the variable i is set to the value of 1.

In Step S602, the portable key 112 transmits the response signal with the transmission intensity SBi. Specifically, the signal processor 154 generates the response signal, and supplies the response signal to the transmitter 145 through the transmission controller 155. Under the control of the transmission controller 155, the transmitter 145 FSK-modulates the response signal, and transmits the modulated response signal through the antenna 146 with the transmission intensity SBi. Note that the measuring signal (FIG. 14) is not necessarily added to the response signal.

In Step S603, whether the reception intensity of the in-vehicle communication device 111 is saturated is determined similarly to the processing in Step S404 of FIG. 13. When the reception intensity of the in-vehicle communication device 111 is determined to be not saturated, the flow goes to the processing in Step S604.

In Step S604, similarly to the processing in Step S405 of FIG. 13, the value of the variable i is incremented by 1.

In Step S605, whether the variable i is greater than the constant m is determined similarly to the processing in Step S406 of FIG. 13. When the variable i is determined to be less than or equal to the constant m, the flow returns to the processing in Step S602.

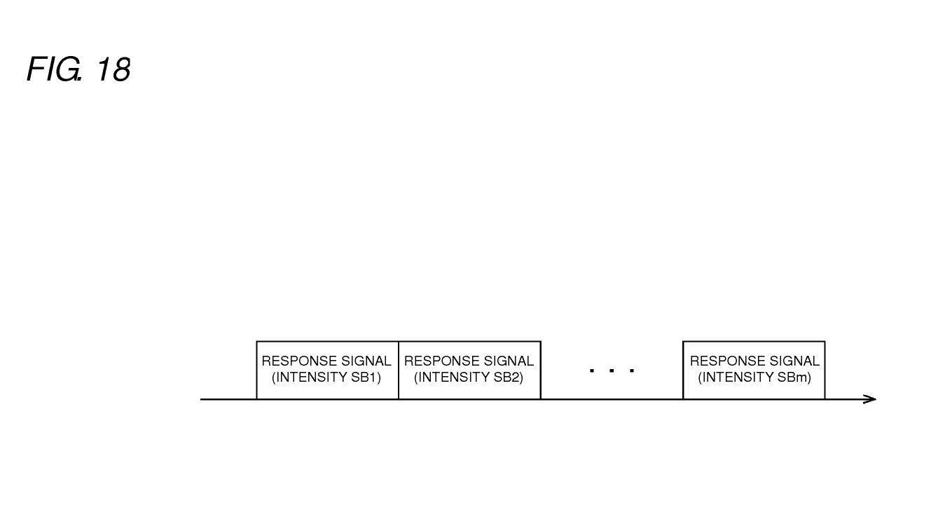

The pieces of processing in Steps S602 to S605 are repeatedly performed until the reception intensity of the in-vehicle communication device 111 is determined to be saturated in Step S603, or until the variable i is determined to be greater than the constant m in Step S605. Therefore, as illustrated in FIG. 18, the response signal is repeatedly transmitted m times with the transmission intensities SB1 to SBm.

The pattern similar to that of the transmission intensity of the measurement portion of the measuring signal in the authentication request signal can be used as the pattern of the transmission intensity of the response signal.

On the other hand, when the variable i is determined to be greater than the constant m in Step S605, namely, when the response signal is transmitted m times, the response signal transmitting processing is ended.

When the reception intensity of the in-vehicle communication device 111 is determined to be saturated in Step S603, the flow goes to the processing in Step S606.

In Step S606, the transmission intensity is wholly lowered similarly to the processing in Step S407 of FIG. 13.

Then, the flow returns to the processing in Step S601, and the pieces of processing from Step S601 are performed. That is, the m-time transmission of the response signal is performed again from the beginning while the transmission intensity is lowered.

(Third Embodiment of Response Signal Receiving Processing Performed by in-Vehicle Communication Device 111)

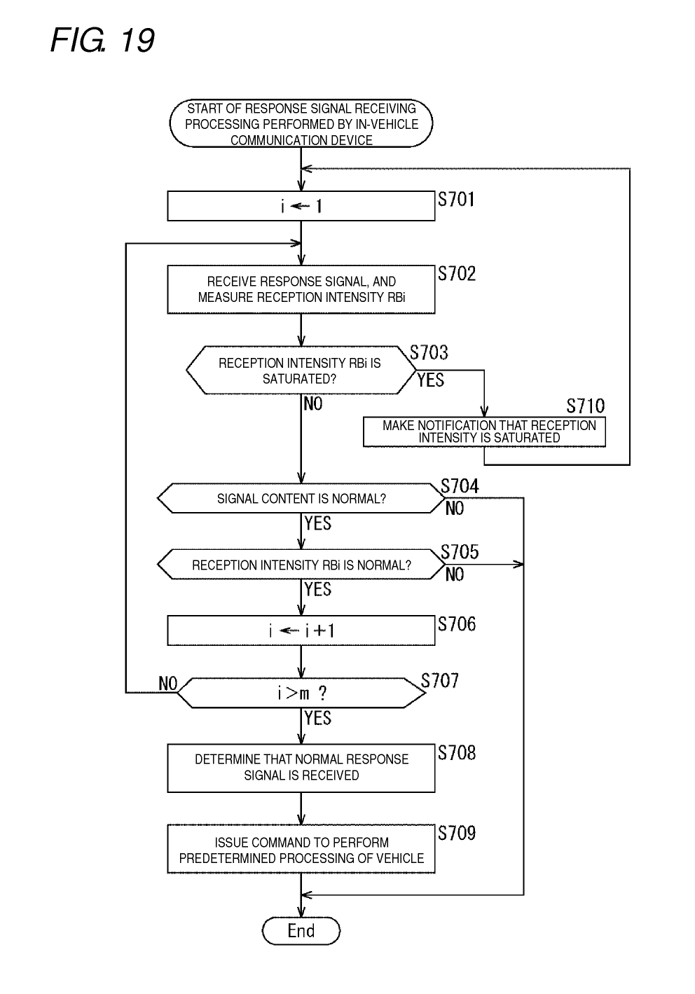

A third embodiment of the response signal receiving processing performed by the in-vehicle communication device 111 in response to the response signal transmitting processing in FIG. 17 performed by the portable key 112 will be described below with reference to a flowchart in FIG. 19. In the third embodiment, the reception intensity RBi of the response signal is determined every time the in-vehicle communication device 111 receives the response signal.

In Step S701, similarly to the processing in Step S503 of FIG. 15, the variable i is set to the value of 1.

In Step S702, the in-vehicle communication device 111 receives the response signal, and receives the reception intensity RBi. Specifically, the receiver 122 receives the response signal transmitted from the portable key 112 through the processing in Step S602 of FIG. 17 through the antenna 121, and demodulates the received response signal. The receiver 122 supplies the demodulated response signal to the signal processor 134 through the reception controller 131.

The receiver 122 supplies the pre-demodulation response signal to the measurement part 132. The measurement part 132 measures the RSSI of the response signal, and notifies the determination part 133 of the measurement result. The determination part 133 stores the notified measurement result as the reception intensity RBi.

In Step S703, whether the reception intensity RBi is saturated is determined similarly to the processing in Step S505 of FIG. 15. When the reception intensity RBi is determined to be not saturated, the flow goes to the processing in Step S704.

In Step S704, whether the signal content is normal is determined similarly to the processing in Step S502 of FIG. 15. When the signal content is determined to be normal, the flow goes to the processing in Step S705.

In Step S705, whether the reception intensity RBi is normal is determined similarly to the processing in Step S506 of FIG. 15. When the reception intensity RBi is determined to be normal, the flow goes to the processing in Step S706.

In Step S706, similarly to the processing in Step S507 of FIG. 15, the value of the variable i is incremented by 1.

In Step S707, whether the variable i is greater than the constant m is determined similarly to the processing in Step S508 of FIG. 15. When the variable i is determined to be less than or equal to the constant m, the flow returns to the processing in Step S702.

The pieces of processing in Steps S702 to S707 are repeatedly performed until the reception intensity RBi is determined to be saturated in Step S703, until the signal content is determined to be abnormal in Step S704, until the reception intensity RBi is determined to be abnormal in Step S705, or until the variable i is determined to be greater than the constant m in Step S707. Therefore, the response signal is received m times, and the reception intensity of each response signal is measured and determined.

On the other hand, when the variable i is determined to be greater than the constant m in Step S707, the flow goes to the processing in Step S708.

In Step S708, the determination part 133 determines that the normal response signal is received. That is, the determination part 133 determines that the normal response signal is received when the response signal content is normal, and the pattern of the reception intensities RB1 to RBm is matched with the pattern of the transmission intensities SB1 to SBm. The determination part 133 notifies the signal processor 134 that the normal response signal is received.

In Step S709, the command to perform the predetermined processing of the vehicle 102 is issued similarly to the processing in Step S510 of FIG. 15. Then the response signal receiving processing is ended.

On the other hand, when the reception intensity RBi is determined to be abnormal in Step S705, the pieces of processing in Steps S706 to S709 are skipped, and the response signal receiving processing is ended without issuing the command to perform the predetermined processing of the vehicle 102.

When the signal content is determined to be abnormal in Step S704, the pieces of processing in Steps S705 to S709 are skipped, and the response signal receiving processing is ended without issuing the command to perform the predetermined processing of the vehicle 102.

When the reception intensity RBi is determined to be saturated in Step S703, the flow goes to the processing in Step S710.

In Step S710, similarly to the processing in Step S511 of FIG. 15, the portable key 112 is notified that the reception intensity is saturated.

Then, the flow returns to the processing in Step S701, and the pieces of processing from Step S701 are performed. That is, the response signal that is transmitted m times from the portable key 112 with the transmission intensity lowered is received again.

As described above, the effect similar to the case that the in-vehicle communication device 111 determines the reception intensity while the portable key 112 transmits the measuring signal of the response signal with the predetermined pattern of the transmission intensity can be obtained, even in the case that the in-vehicle communication device 111 determines the reception intensity while the portable key 112 transmits the response signal m times with the predetermined pattern of the transmission intensity.

(Fourth Embodiment of Authentication Request Signal Receiving Processing Performed by Portable Key 112)

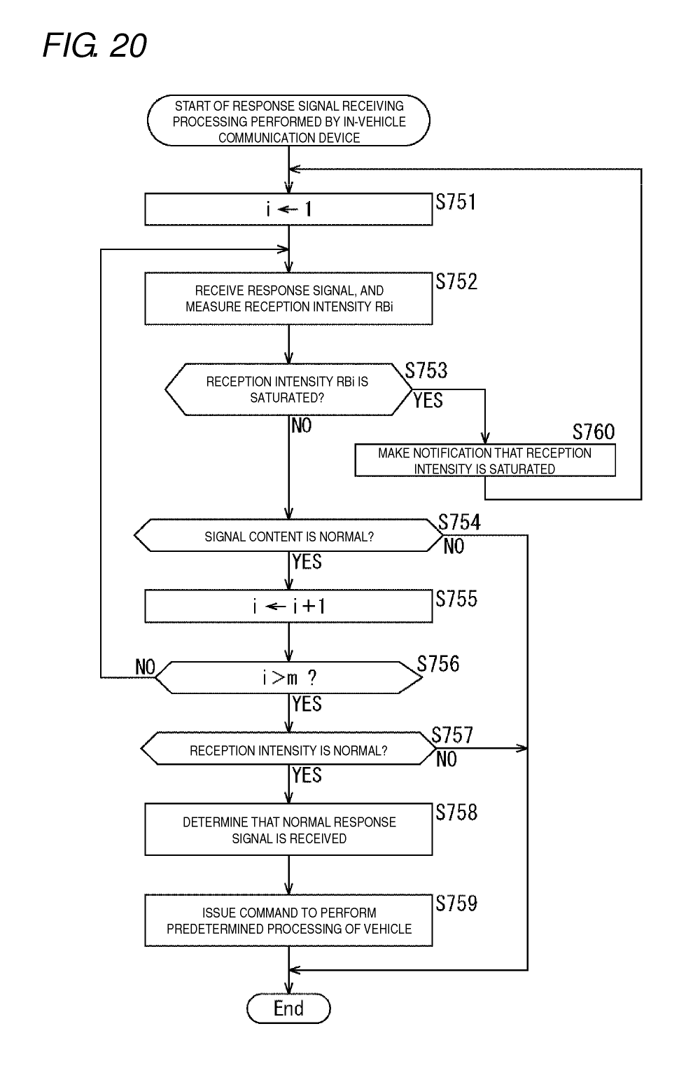

A fourth embodiment of the response signal receiving processing performed by the in-vehicle communication device 111 in response to the response signal transmitting processing in FIG. 17 performed by the portable key 112 will be described below with reference to a flowchart in FIG. 20.

The flowchart in FIG. 20 differs from the flowchart in FIG. 19 only in the position of the reception intensity determination processing. That is, in the flowchart in FIG. 19, whether the reception intensity RBi of the response signal is normal is determined in Step S705 every time the response signal is received. On the other hand, in the flowchart in FIG. 20, similarly to the second embodiment of the response signal receiving processing in FIG. 16, whether the reception intensities RB1 to RBm of the m-time response signal are normal as a whole is determined in Step S757 after the response signal is received n times.

When the reception intensity is determined to be normal in Step S757, the flow goes to the processing in Step S758. The normal response signal is determined to be received in Step S758 similarly to the processing in Step S509 of FIG. 15, and the command to perform the predetermined processing of the vehicle 102 is issued in Step S759 similarly to the processing in Step S510 of FIG. 15. Then the response signal receiving processing is ended. On the other hand, when the reception intensity is determined to be abnormal in Step S757, the pieces of processing in Steps S758 and S759 are skipped, and the response signal receiving processing is ended without issuing the command to perform the predetermined processing of the vehicle 102.

As described above, in one or more embodiments of the present invention, the relay attack in which the repeater 104 is used may be difficult to perform.

### 2. Modifications

Modifications of one or more embodiments of the present invention will be described below.

### First Modification

### Modifications Related to Transmission Intensity Pattern

In the above description, by way of example, the reception intensity is determined while the transmission intensities of both the authentication request signal and the response signal are changed. Alternatively, the reception intensity may be determined while the transmission intensity of one of the authentication request signal and the response signal is changed.

In the above description, by way of example, the transmission intensity of the measuring signal of the authentication request signal or response signal is changed. Alternatively, the reception intensity may be determined while the transmission intensity of part or whole of the information signal is similarly changed.

The transmission intensity pattern is not limited to the above examples, but other pattern may be used as long as the patterns are difficult to reproduce in the repeater 104.

### Second Modification

### Modifications of Determination Position of Reception Intensity Pattern of Portable Key 112

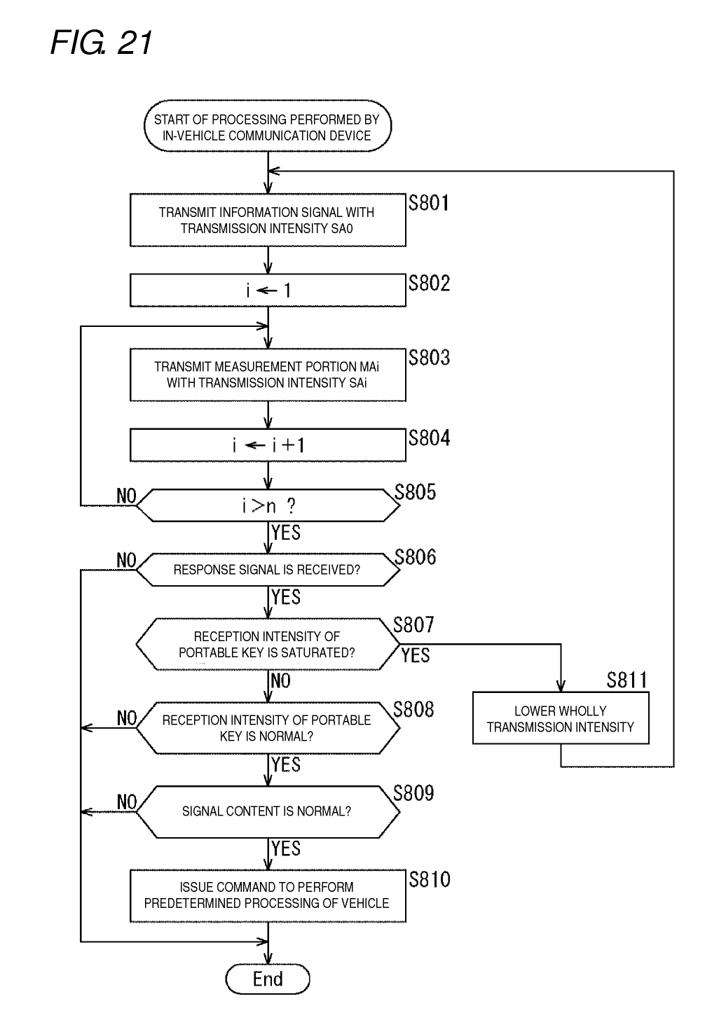

In the above description, by way of example, the reception-side portable key 112 determines the reception intensity of the portable key 112. Alternatively, the transmission-side in-vehicle communication device 111 may determine the reception intensity of the portable key 112. Pieces of processing in the case that the in-vehicle communication device 111 determines the reception intensity of the portable key 112 will be described below with reference to flowcharts in FIG. 21 to FIG. 24.

(First Embodiment of Processing Performed by in-Vehicle Communication Device 111)

A first embodiment of the processing performed by the in-vehicle communication device 111 in the case that the in-vehicle communication device 111 determines the reception intensity of the portable key 112 will be described below with reference to the flowchart in FIG. 21.

For example, the processing is performed when a predetermined operation (for example, the user operates the button provided in the door of the vehicle 102) is performed to the operation part 103 of the vehicle 102, or the processing is periodically performed.

In Step S801, similarly to the processing in Step S1 of FIG. 2, the information signal of the authentication request signal is transmitted with the transmission intensity SA0.

In Step S802, similarly to the processing in Step S2 of FIG. 2, the variable i is set to the value of 1.

In Step S803, similarly to the processing in Step S3 of FIG. 2, the measurement portion MAi of the authentication request signal is transmitted with the transmission intensity SAi.

In Step S804, similarly to the processing in Step S5 of FIG. 2, the value of the variable i is incremented by 1.

In Step S805, similarly to the processing in Step S6 of FIG. 2, whether the variable i is greater than the constant n is determined. When the variable i is determined to be less than or equal to the constant n, the flow returns to the processing in Step S803.

Then, the pieces of processing in Steps S803 to S805 are repeatedly performed until the variable i is determined to be greater than the constant n in Step S804. Therefore, the measurement portions MA1 to MAn of the authentication request signal are transmitted with transmission intensities SA1 to SAn, respectively.

On the other hand, when the variable i is determined to be greater than the constant n in Step S805, namely, when the transmission of all the measurement portions MA1 to MAn of the authentication request signal is completed, the flow goes to the processing in Step S806.

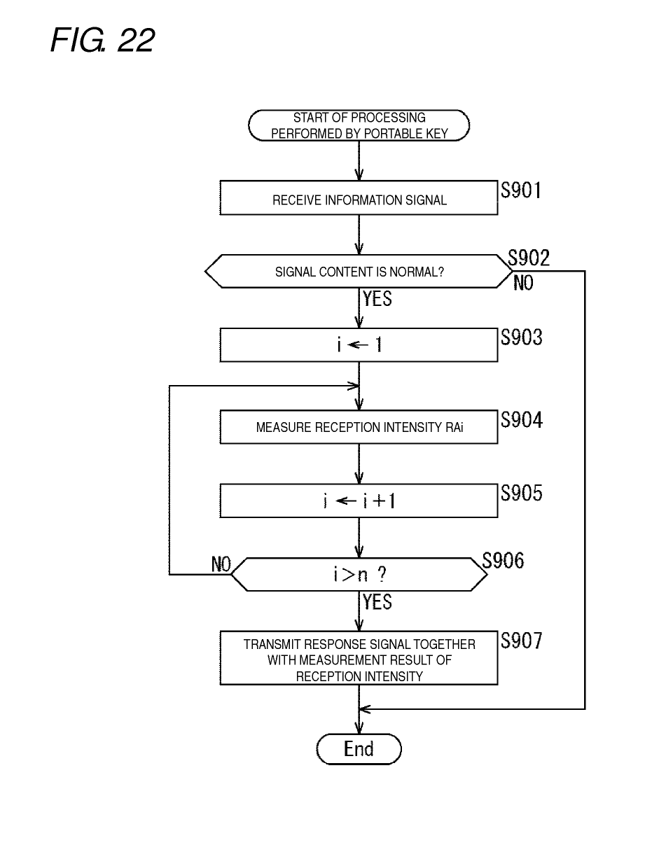

In Step S806, the determination part 133 determines whether the response signal is received. Specifically, when the portable key 112 transmits the response signal in Step S907 of FIG. 22, the receiver 122 receives the response signal through the antenna 121, and demodulates the received response signal. The receiver 122 supplies the demodulated response signal to the determination part 133 and the signal processor 134 through the reception controller 131. The determination part 133 determines that the response signal is received, and the flow goes to processing in Step S807.

In Step S807, the determination part 133 determines whether the reception intensity of the portable key 112 is saturated. Specifically, as described later, the response signal includes the measurement result of the reception intensities RA1 to RAn of the measurement portions MA1 to MAn of the authentication request signal received by the portable key 112. The determination part 133 determines whether the reception intensity of the portable key 112 is saturated based on the measurement result. When the reception intensity of the portable key 112 is determined to be not saturated, the flow goes to the processing in Step S808.

In Step S808, the determination part 133 determines whether the reception intensity of the portable key 112 is normal. Specifically, the determination part 133 checks whether the pattern of the reception intensities RA1 to RAn of the portable key 112 is matched with the pattern of the transmission intensities SA1 to SAn in the in-vehicle communication device 111 based on the measurement result of the reception intensity of the portable key 112. When the pattern of the reception intensities RA1 to RAn is matched with the pattern of the transmission intensities SA1 to SAn, the determination part 133 determines that the reception intensity of the portable key 112 is normal, and the flow goes to the processing in Step S809.

In Step S809, whether the signal content is normal is determined similarly to the processing in Step S502 of FIG. 15. When the signal content is determined to be normal, the flow goes to the processing in Step S810.

In Step S810, the command to perform the predetermined processing of the vehicle 102 is issued similarly to the processing in Step S510 of FIG. 15. Then the processing of the in-vehicle communication device 111 is ended.

On the other hand, when the signal content is determined to be abnormal in Step S809, the processing in Step S810 is skipped, and the processing of the in-vehicle communication device 111 is ended without issuing the command to perform the predetermined processing of the vehicle 102.

When the reception intensity of the portable key 112 is determined to be abnormal in Step S808, the pieces of processing in Steps S809 and S810 are skipped, and the processing of the in-vehicle communication device 111 is ended without issuing the command to perform the predetermined processing of the vehicle 102.

When the reception intensity of the portable key 112 is determined to be saturated in Step S807, the flow goes to the processing in Step S811.

In Step S811, the transmission intensity is wholly lowered similarly to the processing in Step S7 of FIG. 2. The lowering range of the transmission intensity may be set based on the measurement result of the reception intensity of the portable key 112.

Then, the flow returns to the processing in Step S801, and the pieces of processing from Step S801 are performed. That is, the authentication request signal is retransmitted with the transmission intensity lowered.

On the other hand, when determined that the response signal is not received in Step S806 because the portable key 112 does not transmits the response signal in the processing of FIG. 22, the pieces of processing in Steps S807 and S810 are skipped, and the processing of the in-vehicle communication device 111 is ended without issuing the command to perform the predetermined processing of the vehicle 102.

(First Embodiment of Processing Performed by Portable Key 112)

A first embodiment of the processing performed by the portable key 112 in response to the processing in FIG. 21 performed by the in-vehicle communication device 111 in the case that the in-vehicle communication device 111 determines the reception intensity of the portable key 112 will be described below with reference to the flowchart in FIG. 22.

In Step S901, the information signal of the authentication request signal is received similarly to the processing in Step S101 of FIG. 7.

In Step S902, whether the signal content is normal is determined similarly to the processing in Step S102 of FIG. 7. When the signal content is determined to be normal, the flow goes to the processing in Step S903.

In Step S903, similarly to the processing in Step S103 of FIG. 7, the variable is set to the value of 1.

In Step S904, the reception intensity RAi is measured similarly to the processing in Step S105 of FIG. 7.

In Step S905, similarly to the processing in Step S107 of FIG. 7, the value of the variable i is incremented by 1.

In Step S906, whether the variable i is greater than the constant n is determined similarly to the processing in Step S108 of FIG. 7. When the variable i is determined to be less than or equal to the constant n, the flow returns to the processing in Step S904.

Then, the pieces of processing in Steps S904 to S906 are repeatedly performed until the variable i is determined to be greater than the constant n in Step S906. Therefore, the measurement portions MA1 to MAn of the authentication request signal are received to measure the reception intensities RA1 to RAn of the measurement portions MA1 to MAn.

On the other hand, when the variable i is determined to be greater than the constant n in Step S906, the flow goes to the processing in Step S907.

In Step S907, the portable key 112 transmits the response signal together with the measurement result of the reception intensity. Specifically, the determination part 153 notifies the signal processor 154 of the measurement result of the reception intensities RA1 to RAn of the measurement portions MA1 to MAn of the authentication request signal. The signal processor 154 generates the response signal including the measurement result of the reception intensities RA1 to RAn, and supplies the response signal to the transmitter 145 through the transmission controller 155. Under the control of the transmission controller 155, the transmitter 145 FSK-modulates the response signal, and transmits the modulated response signal through the antenna 146.

Then the processing of the portable key 112 is ended.

On the other hand, when the signal content is determined to be abnormal in Step S902, the pieces of processing in Steps S903 to S907 are skipped, and the processing of the portable key 112 is ended without transmitting the response signal.

(Second Embodiment of Processing Performed by in-Vehicle Communication Device 111)

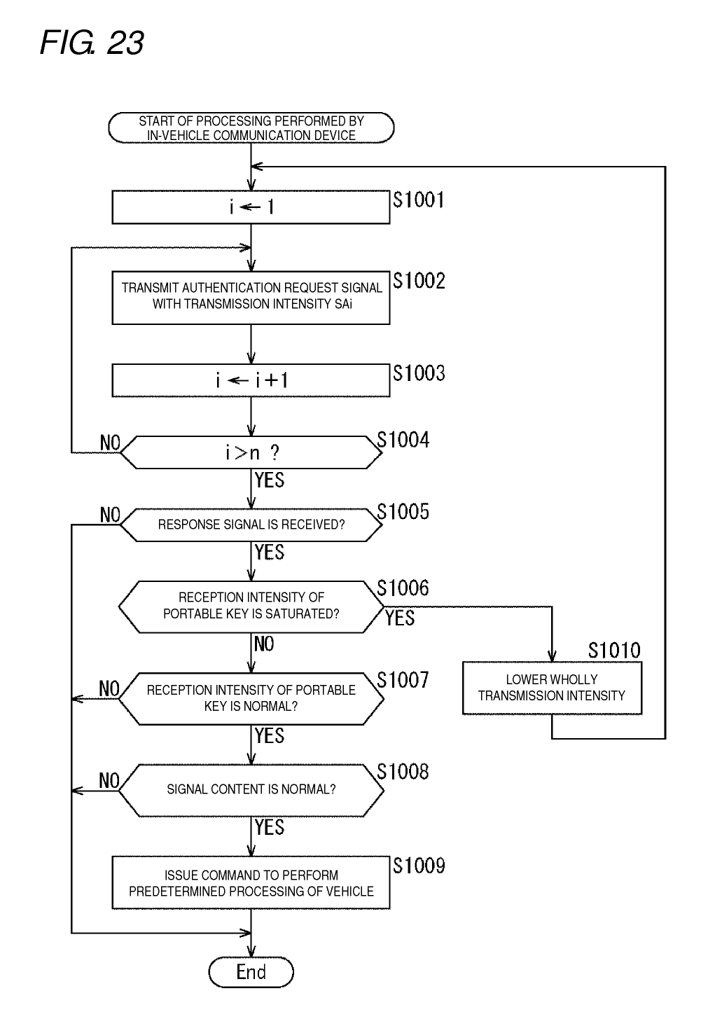

A second embodiment of the processing performed by the in-vehicle communication device 111 in the case that the in-vehicle communication device 111 determines the reception intensity of the portable key 112 will be described below with reference to the flowchart in FIG. 23. In the second embodiment, instead of changing the transmission intensity of the measuring signal of the authentication request signal, the authentication request signal is transmitted predetermined times, and the transmission intensity of each authentication request signal is changed according to the predetermined pattern.

For example, the processing of the communication system 101 is performed when a predetermined operation (for example, the user operates the button provided in the door of the vehicle 102) is performed to the operation part 103 of the vehicle 102, or the processing is periodically performed.

In Step S1001, similarly to the processing in Step S2 of FIG. 2, the variable i is set to the value of 1.

In Step S1002, similarly to the processing in Step S202 of FIG. 9, the authentication request signal is transmitted with the transmission intensity SAi.

In Step S1003, similarly to the processing in Step S5 of FIG. 2, the value of the variable i is incremented by 1.

In Step S1004, whether the variable i is greater than the constant n is determined similarly to the processing in Step S6 of FIG. 2. When the variable i is determined to be less than or equal to the constant n, the flow returns to the processing in Step S1002.

Then, the pieces of processing in Steps S1002 to S1004 are repeatedly performed until the variable i is determined to be greater than the constant n in Step S1004. Therefore, the authentication request signal is transmitted n times with transmission intensities SA1 to SAn.

On the other hand, when the variable i is determined to be greater than the constant n in Step S1004, namely, when the authentication request signal is transmitted n times, the flow goes to the processing in Step S1005.

Then, the pieces of processing similar to those in Steps S806 to S811 of FIG. 21 are performed in Steps S1005 to S1010, and the processing of the in-vehicle communication device 111 is ended.

(First Embodiment of Processing Performed by Portable Key 112)

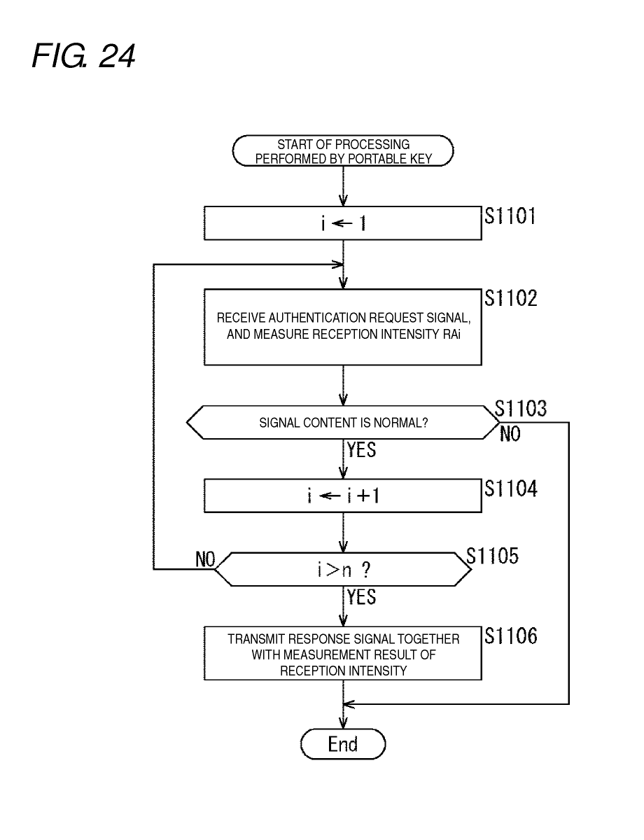

A second embodiment of the processing performed by the portable key 112 in response to the processing in FIG. 23 performed by the in-vehicle communication device 111 in the case that the in-vehicle communication device 111 determines the reception intensity of the portable key 112 will be described below with reference to the flowchart in FIG. 24.

In Step S1101, similarly to the processing in Step S103 of FIG. 7, the variable i is set to the value of 1.

In Step S1102, similarly to the processing in Step S302 of FIG. 11, the authentication request signal is received and the reception intensity RAi is measured.

In Step S1103, whether the signal content is normal is determined similarly to the processing in Step S304 of FIG. 11. When the signal content is determined to be normal, the flow goes to the processing in Step S1104.

In Step S1104, similarly to the processing in Step S107 of FIG. 7, the value of the variable i is incremented by 1.

In Step S1105, whether the variable i is greater than the constant n is determined similarly to the processing in Step S108 of FIG. 7. When the variable i is determined to be less than or equal to the constant n, the flow returns to the processing in Step S1102.

Then the pieces of processing in Steps S1102 to S1105 are repeatedly performed until the signal content is determined to be abnormal in Step S1103, or until the variable i is determined to be greater than the constant n in Step S1105. Therefore, the authentication request signal is received n times, and the reception intensity of each authentication request signal is measured.

On the other hand, when the variable i is determined to be greater than the constant n in Step S1105, namely, when the authentication request signal is received n times, the flow goes to the processing in Step S1106.

In Step S1106, similarly to the processing in Step S907 of FIG. 22, the response signal is transmitted together with the measurement result of the reception intensity. Then the processing of the portable key 112 is ended.

On the other hand, when the signal content is determined to be abnormal in Step S1103, the pieces of processing in Steps S1104 to S1106 are skipped, and the processing of the portable key 112 is ended without transmitting the response signal.

As described above, the in-vehicle communication device 111 determines the reception intensity of the portable key 112 to reduce a load on the processing of the portable key 112. Therefore, for example, a life of a battery driving the portable key 112 can be prolonged.

### Third Modification

### Modifications Related to Device Configuration

The configuration of the in-vehicle communication device 111 is not limited to the example in FIG. 1, but various changes can be made. For example, the reception controller 131 and the transmission controller 135 may be provided outside the controller 123, or the receiver 122 and the transmitter 124 may be provided in the controller 123. For example, the receiver 122 and the reception controller 131 may be combined, or the transmitter 124 and the transmission controller 135 may be combined. For example, the receiver 122 and the transmitter 124 may be combined. In the in-vehicle communication device 111, the portion in which the transmission processing is performed and the portion in which the reception processing is performed may be divided into two devices.

Similarly, the configuration of the portable key 112 is not limited to the example in FIG. 1, but various changes can be made. For example, the reception controller 151 and the transmission controller 155 may be provided outside the controller 144, or the receiver 142 and the transmitter 145 may be provided in the controller 144. For example, the receiver 142 and the reception controller 151 may be combined, or the transmitter 145 and the transmission controller 155 may be combined. For example, the receiver 142 and the transmitter 145 may be combined.

The number of portable keys 112 is not limited to one, but at least two portable keys 112 may be provided. The number of in-vehicle communication devices 111 is not limited to one, but at least two in-vehicle communication devices 111 may be provided.

### Fourth Modification

### Other Modifications

In the above description, in the case that the reception intensity is saturated on the reception side while the intensity of the measuring signal of the authentication request signal or response signal is changed, by way of example, the authentication request signal or the response signal is retransmitted from the beginning. Alternatively, the information signal may not be retransmitted, but only the measuring signal may be retransmitted with the transmission intensity lowered.

The reception side may notify the transmission side that the reception intensity is saturated, and the processing of retransmitting the signal from the transmission side may be eliminated.

There is no particular limitation to a kind of the vehicle to which one or more embodiments of the present invention is applied. For example, one or more embodiments of the present invention can be applied to not only four-wheel vehicles such as an automobile but also other kinds of vehicles such as a two-wheel vehicle.

One or more embodiments of the present invention can also be applied to a wireless communication system except the vehicle. For example, one or more embodiments of the present invention can effectively be applied to a system in which one of the communication devices automatically transmits the response signal in response to the request from the other communication device. For example, one or more embodiments of the present invention is effectively applied to the system in which the authentication request signal is transmitted to the portable key from the communication device provided in a building when a door of the building is operated, and the door is locked or unlocked in response to the response signal from the portable key.

[Configuration Example of Computer]

The series of pieces of processing can be performed by hardware or software. In the case that the series of pieces of processing are performed by the software, a program constituting the software is installed in the computer. Examples of the computer include a computer incorporated in the dedicated hardware and a general-purpose personal computer in which various programs are installed to be able to perform various functions.

For example, the program executed by the computer can be provided while recorded in a removable medium as a package medium. The program can also be provided through a wireless or wired transmission medium such as a local area network, the Internet, and a digital satellite broadcasting.

For example, the program can previously be installed in the ROM or storage part.

The program may be executed by the computer in time series along the procedure of one or more embodiments, concurrently executed by the computer, or executed by the computer in necessary timing such as calling.

As used herein, the system means a set of a plurality of structural elements (such as the device and a module (component)) whether all the structural elements exist in a chassis or not. Accordingly, both a plurality of devices accommodated in individual chassis while connected to each other through a network and one device in which a plurality of modules are accommodated in one chassis are the system.

The present invention is not limited to the above embodiments, but various changes can be made without departing from the scope of the present invention.

Each step described in the flowcharts can be performed by one device, or the step can be performed while shared by a plurality of devices.

In the case that a plurality of pieces of processing are included in one step, the plurality of pieces of processing included in the one step can be performed by one device, or the plurality of pieces of processing included in the one step can be performed by the plurality of devices while shared by the plurality of devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A communication system comprising:
a first communication device; and
a second communication device that conducts wireless communication with the first communication device,
wherein the first communication device comprises:
a first transmitter that transmits a signal to the second communication device, and
a first transmission controller that controls the first transmitter,
wherein the second communication device comprises:
a first receiver that receives the signal from the first communication device,
a measurement part that measures a reception intensity of the signal received by the first receiver, and
a determination part that determines whether the signal received by the first receiver is a normal signal,
wherein the first transmission controller divides a predetermined portion of a predetermined signal into a plurality of portions when transmitting the predetermined signal, and adjusts a transmission intensity of each divided portion such that a change in transmission intensity has a predetermined pattern in the whole predetermined portion of the predetermined signal,
wherein the measurement part measures the reception intensity of the predetermined portion of the predetermined signal, and
wherein the determination part determines whether the predetermined signal is the normal signal based on whether the change in reception intensity of the predetermined portion of the predetermined signal is matched with the predetermined pattern.

2. The communication system according to claim 1,
wherein the first communication device further comprises:
a second receiver that receives a signal from the second communication device,
wherein the second communication device further comprises:
a second transmitter that transmits the signal to the first communication device, and
a second transmission controller that controls the second transmitter,
wherein the second transmission controller performs control so as to transmit a signal making notification that the reception intensity is saturated, when the reception intensity of the predetermined portion of the predetermined signal is saturated, and
wherein the first transmission controller performs control such that retransmission is performed while the transmission intensity of at least the predetermined portion is lowered, when the notification that the reception intensity is saturated is made.

3. The communication system according to claim 1,
wherein the first transmission controller performs control such that notification of information on the predetermined pattern is made while the information on the predetermined pattern is included in the predetermined signal content, and
wherein the determination part determines whether the predetermined signal is the normal signal based on the notified predetermined pattern.

4. A communication device that conducts wireless communication with another communication device, comprising:
a transmitter that transmits a signal to the another communication device; and
a transmission controller that controls the transmitter,
wherein the transmission controller divides a predetermined portion of a predetermined signal into a plurality of portions when transmitting the predetermined signal, and adjusts a transmission intensity of each divided portion such that a change in transmission intensity has a predetermined pattern in the whole predetermined portion of the predetermined signal.

5. A communication device that conducts wireless communication with another communication device, comprising:
a receiver that receives a signal from the another communication device;
a measurement part that measures a reception intensity of the signal received by the receiver; and
a determination part that determines whether the signal received by the receiver is a normal signal,
wherein the measurement part measures the reception intensity of a predetermined portion of a predetermined signal transmitted from the another communication device, and
the determination part determines whether the predetermined signal is the normal signal based on whether the change in reception intensity of the predetermined portion of the predetermined signal is matched with a predetermined pattern.

6. A communication system comprising:
a first communication device; and
a second communication device that conducts wireless communication with the first communication device,
wherein the first communication device comprises:
a first transmitter that transmits a signal to the second communication device, and
a first transmission controller that controls the first transmitter,
wherein the second communication device comprises:
a first receiver that receives the signal from the first communication device,
a measurement part that measures a reception intensity of the signal received by the first receiver, and
a determination part that determines whether the signal received by the first receiver is a normal signal,
wherein the first transmission controller performs control such that a predetermined signal is repeatedly transmitted predetermined times and such that a change in transmission intensity between the predetermined signals is changed according to a predetermined pattern,
wherein the measurement part measures the reception intensities of the predetermined signals that are repeatedly transmitted the predetermined times, and
wherein the determination part determines whether the predetermined signal is the normal signal based on whether the change in reception intensity between the predetermined signals is matched with the predetermined pattern.

7. The communication system according to claim 6,
wherein the first communication device further comprises:
a second receiver that receives a signal from the second communication device,
wherein the second communication device further comprises:
a second transmitter that transmits the signal to the first communication device, and
a second transmission controller that controls the second transmitter,
wherein the second transmission controller performs control so as to transmit a signal making notification that the reception intensity is saturated, when the reception intensity of the predetermined signal is saturated, and
wherein the first transmission controller performs control such that the predetermined signal is repeatedly retransmitted predetermined times while the transmission intensity is lowered, when the notification that the reception intensity is saturated is made.

8. The communication system according to claim 6,
wherein the first transmission controller performs control such that notification of information on the predetermined pattern is made while the information on the predetermined pattern is included in one or all of the predetermined signals transmitted a plurality of times, and
wherein the determination part determines whether the predetermined signal is the normal signal based on the notified predetermined pattern.

9. A communication device that conducts wireless communication with another communication device, comprising:
a transmitter that transmits a signal to the another communication device; and
a transmission controller that controls the transmitter,
wherein the transmission controller performs control such that a predetermined signal is repeatedly transmitted predetermined times and such that a change in transmission intensity between the predetermined signals is changed according to a predetermined pattern.

10. A communication device that conducts wireless communication with another communication device, comprising:
a receiver that receives a signal from the another communication device;
a measurement part that measures a reception intensity of the signal received by the receiver; and
a determination part that determines whether the signal received by the first receiver is a normal signal,
wherein the measurement part measures the reception intensities of the predetermined signals that are repeatedly transmitted the predetermined times from the another communication device, and
wherein the determination part determines whether the predetermined signal is the normal signal based on whether the change in reception intensity between the predetermined signals is matched with a predetermined pattern.

11. A communication system comprising:
a first communication device; and
a second communication device that conducts wireless communication with the first communication device,
wherein the first communication device comprises:
a first transmitter that transmits a signal to the second communication device,
a first transmission controller that controls the first transmitter,
a first receiver that receives a signal from the second communication device, and
a determination part that determines whether the signal received by the second communication device is a normal signal,
wherein the second communication device comprises:
a second receiver that receives the signal from the first communication device,
a measurement part that measures a reception intensity of the signal received by the second receiver,
a second transmitter that transmits the signal to the first communication device, and
a second transmission controller that controls the second transmitter,
wherein the first transmission controller divides a predetermined portion of a predetermined first signal into a plurality of portions when transmitting the first signal, and adjusts a transmission intensity of each divided portion such that a change in transmission intensity has a predetermined pattern in the whole predetermined portion of the first signal,
wherein the measurement part measures the reception intensity of the predetermined portion of the first signal,
wherein the second transmission controller performs control so as to transmit a second signal including a measurement result of the reception intensity of the predetermined portion of the first signal in response to the first signal, and
wherein the determination part determines whether the first signal received by the second communication device is the normal signal based on whether the change in reception intensity of the predetermined portion of the first signal in the second communication device is matched with the predetermined pattern.

12. The communication system according to claim 11, wherein the first transmission controller performs control such that retransmission is performed while the transmission intensity of at least the predetermined portion is lowered, when the reception intensity of the predetermined portion of the first signal is saturated in the second communication device.

13. A communication device that conducts wireless communication with another communication device, comprising:
a transmitter that transmits a signal to the another communication device;
a transmission controller that controls the transmitter;
a receiver that receives a signal from the another communication device; and
a determination part that determines whether the signal received by the another communication device is a normal signal,
wherein the transmission controller divides a predetermined portion of a predetermined first signal into a plurality of portions when transmitting the first signal, and adjusts a transmission intensity of each divided portion such that a change in transmission intensity has a predetermined pattern in the whole predetermined portion of the first signal, and
wherein the determination part determines whether the first signal received by the second communication device is the normal signal by determining whether the change in reception intensity of the predetermined portion of the first signal in the second communication device is matched with the predetermined pattern based on a measurement result of the reception intensity of the predetermined portion of the first signal, the measurement result of the reception intensity of the predetermined portion of the first signal being included in a second signal transmitted from the another communication device in response to the first signal.

14. A communication device that conducts wireless communication with another communication device, comprising:
a receiver that receives a signal from the another communication device;
a measurement part that measures a reception intensity of the signal received by the receiver;
a transmitter that transmits a signal to the another communication device; and
a transmission controller that controls the transmitter,
wherein the measurement part measures the reception intensity of a predetermined portion of a predetermined first signal transmitted from the another communication device, and
wherein the transmission controller performs control so as to transmit a second signal including a measurement result of the reception intensity of the predetermined portion of the first signal in response to the first signal.

15. A communication system comprising:
a first communication device; and
a second communication device that conducts wireless communication with the first communication device,
wherein the first communication device comprises:
a first transmitter that transmits a signal to the second communication device,
a first transmission controller that controls the first transmitter,
a first receiver that receives a signal from the second communication device, and
a determination part that determines whether the signal received by the second communication device is a normal signal,
wherein the second communication device comprises:
a second receiver that receives the signal from the first communication device,
a measurement part that measures a reception intensity of the signal received by the second receiver,
a second transmitter that transmits the signal to the first communication device, and
a second transmission controller that controls the second transmitter,
wherein the first transmission controller performs control such that a predetermined first signal is repeatedly transmitted predetermined times and such that a change in transmission intensity between the first signals is changed according to a predetermined pattern,
wherein the measurement part measures the reception intensities of the first signals that are repeatedly transmitted the predetermined times,
wherein the second transmission controller performs control so as to transmit a second signal including a measurement result of the reception intensity of the first signal in response to the first signal, and
wherein the determination part determines whether the first signal received by the second communication device is the normal signal based on whether the change in reception intensity between the first signals in the second communication device is matched with the predetermined pattern.

16. The communication system according to claim 15, wherein the first transmission controller performs control such that the first signal is retransmitted predetermined times while the transmission intensity is lowered, when the reception intensity of the first signal is saturated in the second communication device.

17. A communication device that conducts wireless communication with another communication device, comprising:
a transmitter that transmits a signal to the another communication device;
a transmission controller that controls the transmitter;
a receiver that receives a signal from the another communication device; and
a determination part that determines whether the signal received by the another communication device is a normal signal,
wherein the transmission controller performs control such that a predetermined first signal is repeatedly transmitted predetermined times and such that a change in transmission intensity between the first signals is changed according to a predetermined pattern,
wherein the measurement part measures the reception intensities of the first signals that are repeatedly transmitted the predetermined times, and
wherein the determination part determines whether the first signal received by the second communication device is the normal signal by determining whether the change in reception intensity between the first signals in the second communication device is matched with the predetermined pattern based on a measurement result of the reception intensity of the first signal, the measurement result of the reception intensity of the first signal being included in a second signal transmitted from the another communication device in response to the first signal.

18. A communication device that conducts wireless communication with another communication device, comprising:
a receiver that receives a signal from the another communication device;
a measurement part that measures a reception intensity of the signal received by the receiver;
a transmitter that transmits a signal to the another communication device; and
a transmission controller that controls the transmitter,
wherein the measurement part measures the reception intensities of predetermined first signals that are repeatedly transmitted the predetermined times from the another communication device, and
wherein the transmission controller performs control so as to transmit a second signal including a measurement result of the reception intensity of the first signal in response to the first signal.
